(19) United States
(12) Patent Application Publication
(10) Pub. No.: US 2016/0154374 A1
(43) Pub. Date: Jun. 2, 2016

(54) IMAGE FORMING APPARATUS

(71) Applicant: CANON KABUSHIKI KAISHA, Tokyo (JP)

(72) Inventors: Daisuke Hiramatsu, Numazu-shi (JP); Tetsuya Numata, Suntou-gun (JP); Takayuki Yada, Suntou-gun (JP)

(21) Appl. No.: 14/948,678

(22) Filed: Nov. 23, 2015

(30) Foreign Application Priority Data
Nov. 28, 2014 (JP) 2014-242593

(51) Int. Cl. G03G 21/18

(52) U.S. Cl. CPC G03G 21/1839

(57) ABSTRACT

An image forming apparatus includes a cartridge supporting member configured to move with respect to a main body of the apparatus in a state in which a cartridge is mounted to take a mounting and demounting position where the cartridge supporting member is located at an exterior of the main body and allowing the cartridge to be mounted and demounted, and an image forming position where the cartridge supporting member is located within an interior of the main body to locate the cartridge at a position which allows formation of an image. A first unit of the cartridge includes a position-restricted portion, and the cartridge is located below a second unit in which the cartridge is mounted on the cartridge supporting member. The cartridge supporting member includes a position restricting portion configured to restrict movement of the cartridge with respect to the cartridge supporting member by engaging the position-restricted portion.

### BACKGROUND OF THE INVENTION

1. Field of the Invention

Technical Field

This disclosure relates to an image forming apparatus. The image forming apparatus is configured to form an image on a recording medium. Examples of the image forming apparatus include, for example, electrophotographic copying machines, electrophotographic printers (such as LED printers, laser beam printers), facsimile apparatuses, and word processors.

2. Description of the Related Art

Background Art

An electrophotographic image forming apparatus (hereinafter, also referred to simply as “image forming apparatus”) is configured to uniformly charge an electrophotographic photosensitive member, that is, a photosensitive drum. The electrophotographic photosensitive member is an image bearing member generally having a drum shape. Next, the charged photosensitive drum is selectively exposed to form an electrostatic latent image (electrostatic image) on the photosensitive drum). The electrostatic latent image formed on the photosensitive drum is then developed as a toner image by using toner as a developer. The toner image formed on the photosensitive drum is transferred to a recording material such as a recording sheet or a plastic sheet, and then heat and pressure are applied to the toner image that has been transferred onto the recording material to fix the toner image to the recording material, thereby completing the image recording.

The image forming apparatus as described above generally needs replenishing of toner and maintenance of various process devices. In order to facilitate replenishing of toner and maintenance described above, a configuration of a process cartridge which accommodates the photosensitive drum, a charging device, a developing device, a cleaning device, and the like in a frame member so as to be mountable and demountable with respect to a main body of the image forming apparatus has already been put into practical use.

According to the cartridge system described above, since a user can perform maintenance of the apparatus on his/her own, operability is significantly improved, and hence an image forming apparatus having superior usability is provided. Therefore, the cartridge system described above is widely used in the field of image forming apparatuses.

The cartridge system described above includes a configuration as disclosed in Japanese Patent Laid-Open No. 2009-157389 in which a tray that is removable from the main body of the image forming apparatus is disposed and a process cartridge can be mounted in a state in which the tray is pulled out from the main body. The image forming apparatus described above has a configuration having high usability because the user is allowed to replace the process cartridge without putting his or her hand into an interior of the main body of the image forming apparatus.

However, with the configuration disclosed in Japanese Patent Laid-Open No. 2009-157389, a space for disposing the tray is required in the interior of the main body of the image forming apparatus, which may result in an increase in the size of the image forming apparatus.

### SUMMARY OF THE INVENTION

The present invention provides a configuration in which a cartridge is mounted on a main body of an image forming apparatus by using a cartridge supporting member with the intention of reducing the size of the cartridge supporting member.

According to an aspect of the invention, there is provided an image forming apparatus including: a main body of the apparatus; a cartridge having a first unit and a second unit pivotably coupled to the first unit; and a cartridge supporting member configured to be movable with respect to the main body in a state in which the cartridge is mounted to take a mounting and demounting position where the cartridge supporting member is located at an exterior of the main body and allowing the cartridge to be mounted and demounted and an image forming position where the cartridge supporting member is located within an interior of the main body and configured to locate the cartridge at a position which allows formation of an image, wherein the first unit includes a position-restricted portion, and is located below the second unit in a state in which the cartridge is mounted on the cartridge supporting member, and the cartridge supporting member includes a position restricting portion configured to restrict movement of the cartridge with respect to the cartridge supporting member by coming into contact with the position-restricted portion.

Further features of the present invention will become apparent from the following description of exemplary embodiments with reference to the attached drawings.

### BRIEF DESCRIPTION OF THE DRAWINGS

FIG. 1 is a cross-sectional view of a main body of the image forming apparatus of an electrophotographic image forming apparatus according to Example 1 illustrating a state when a process cartridge is mounted on a tray in a state in which an opening and closing door of the main body of the electrophotographic image forming apparatus is opened.

FIG. 2 is a cross-sectional view illustrating the main body and a process cartridge of the electrophotographic image forming apparatus in Example 1.

FIG. 3 is a cross-sectional view of the process cartridge in Example 1.

FIG. 4A is a cross-sectional view taken along the line IVA-IVA in FIG. 4B illustrating an interior of the cleaning container of the process cartridge in Example 1.

FIG. 4B is a side view of the process cartridge in Example 1.

FIG. 5 is a perspective view of the main body of the electrophotographic image forming apparatus in Example 1 in a state in which the opening and closing door thereof is opened.

FIG. 6 is a perspective view of the main body of the electrophotographic image forming apparatus in Example 1 in the state in which the opening and closing door thereof is opened and the tray is pulled out.

FIG. 7 is a perspective view of the main body of the electrophotographic image forming apparatus and the process cartridge illustrating a state in which the process cartridge is mounted and demounted with respect to the tray in a state in which the opening and closing door of the image forming apparatus in Example 1 is opened and the tray is pulled out.

FIG. 8 is a perspective view of the process cartridge and drive-side supporting portions of the main body of the image forming apparatus in a state in which the process cartridge is mounted on a main body of the electrophotographic image forming apparatus in Example 1.

FIG. 9 is a perspective view of the process cartridge and non-drive-side supporting portions of the main body of the image forming apparatus in the state in which the process cartridge is mounted on the main body of the electrophotographic image forming apparatus in Example 1.

FIG. 10 is an exploded view illustrating the process cartridge in Example 1.

FIG. 11 is an exploded view illustrating the process cartridge in Example 1.

FIG. 12 is an exploded view illustrating the process cartridge in Example 1.

FIG. 13 is an exploded view illustrating the process cartridge in Example 1.

FIG. 14 is a perspective view illustrating a state of mounting the process cartridge on the tray in Example 1.

FIG. 15 is a perspective view illustrating the state of mounting the process cartridge on the tray in Example 1.

FIG. 16 is a cross-sectional view of the tray in the state of mounting the process cartridge on the tray in Example 1.

FIG. 17 is a cross-sectional view of the tray in the state of mounting the process cartridge on the tray in Example 1.

FIG. 18 is a cross-sectional view of the tray in the state of mounting the process cartridge on the tray in Example 1.

FIG. 19 is a schematic illustration of a main body of the apparatus in a state in which the tray is moved from a mounting and demounting position to an image forming position in a state in which the process cartridge in Example 1 is mounted on the tray.

FIG. 20 is a schematic illustration of the main body of the apparatus when moving the tray from the mounting and demounting position to the image forming position in the state in which the process cartridge is mounted on the tray in Example 1.

FIG. 21 is a schematic illustration of the main body of the apparatus when moving the tray from the mounting and demounting position to the image forming position in the state in which the process cartridge is mounted on the tray in Example 1.

FIG. 22 is a schematic illustration of the main body of the apparatus when the tray is at the image forming position in the state in which the process cartridge is mounted on the tray in Example 1.

FIG. 23 is a schematic illustration of the main body of the apparatus when moving the tray from the image forming position to the mounting and demounting position in the state in which the process cartridge is mounted on the tray in Example 1.

FIG. 24 is a schematic illustration of the main body of the apparatus when moving the tray from the image forming position to the mounting and demounting position in a state in which the process cartridge is mounted on the tray in Example 1.

FIG. 25 is a schematic illustration of the main body of the apparatus when the tray is at the image forming position in the state in which the process cartridge is mounted on the tray in Example 1.

FIG. 26 is a cross-sectional view of a main body of an electrophotographic image forming apparatus in a state in which a process cartridge is mounted on a tray in a state in which the opening and closing door of the main body of the electrophotographic image forming apparatus is opened according to a second embodiment when the process cartridge is mounted on the tray in Example 2.

FIGS. 27A and 27B are perspective views illustrating a state of mounting the process cartridge on the tray in Example 2.

FIGS. 28A and 28B are perspective views illustrating a state of mounting the process cartridge on the tray in Example 2.

FIG. 29 is a cross-sectional view of the tray in a state of mounting the process cartridge on the tray in Example 2.

FIG. 30 is a cross-sectional view of the tray in the state of mounting the process cartridge on the tray in Example 2.

FIG. 31 is a cross-sectional view of the tray in the state of mounting the process cartridge is mounted on the tray in Example 2.

FIG. 32 is a schematic illustration of the main body of the apparatus when moving the tray from a mounting and demounting position to an image forming position in the state in which the process cartridge is mounted on the tray in Example 2.

FIG. 33 is a schematic illustration of the main body of the apparatus when moving the tray from the mounting and demounting position to the image forming position in the state in which the process cartridge is mounted on the tray in Example 2.

FIG. 34 is a schematic illustration of the main body of the apparatus when the tray is at the image forming position in the state in which the process cartridge is mounted on the tray in Example 2.

FIG. 35 is a schematic illustration of the main body of the apparatus when moving the tray from the image forming position to the mounting and demounting position in the state in which the process cartridge is mounted on the tray in Example 2.

FIG. 36 is a schematic illustration of the main body of the apparatus when moving the tray from the image forming position to the mounting and demounting position in a state in which the process cartridge is mounted on the tray in Example 2.

### DESCRIPTION OF THE EMBODIMENTS

### EXAMPLE 1

An embodiment of this disclosure will be described in detail with reference to the drawings below.

A direction of a rotational axis of an electrophotographic photosensitive drum is defined as a longitudinal direction.

In the longitudinal direction, a side on which the photoelectric photosensitive drum receives a drive force from a main body of the image forming apparatus (a side on which a coupling 14 described later is provided on a cartridge B) is defined as a drive-side. An opposite side to the drive-side is defined as a non-drive-side.

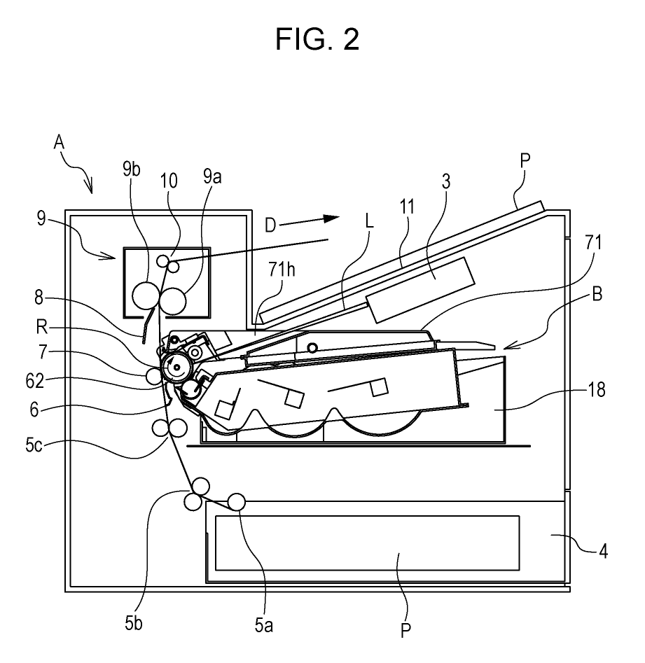

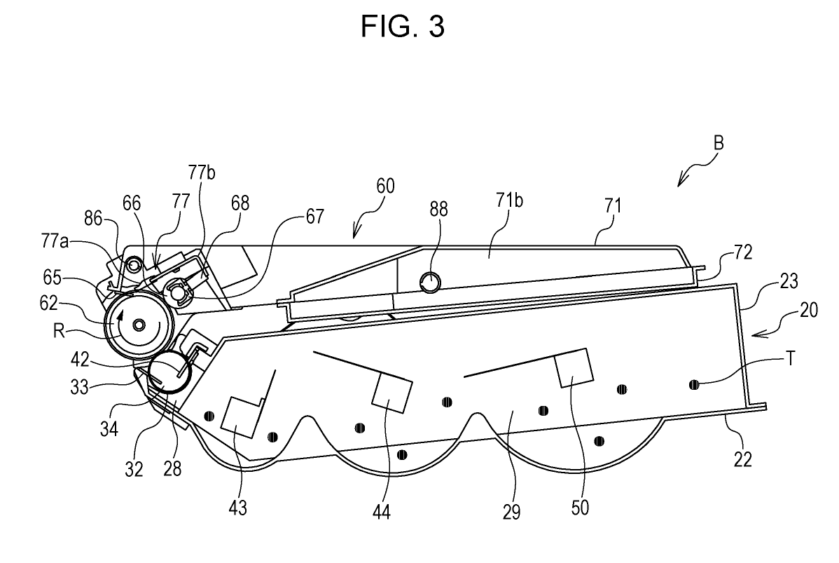

A general configuration and an image forming process will be described with reference to FIG. 2 and FIG. 3.

FIG. 2 is a cross-sectional view illustrating the main body of the electrophotographic image forming apparatus (hereinafter, referred to as a main body A) and a process cartridge (hereinafter, referred to as a cartridge B) as an embodiment of this disclosure.

FIG. 3 is a cross-sectional view of the cartridge B.

The term “main body A” here corresponds to a portion of the electrophotographic image forming apparatus excluding the cartridge B and a tray 18 (a detailed description will be given later).

### General Configuration of Electrophotographic Image Forming Apparatus

The electrophotographic image forming apparatus illustrated in FIG. 2 is a laser beam printer using an electrophotographic technology. The cartridge B is demountably mounted on the main body A. When the cartridge B is mounted on the main body A, an exposing unit 3 (laser scanner unit) for forming a latent image on an electrophotographic photosensitive drum 62 of the cartridge B is arranged into position. A sheet tray 4 in which recording media (hereinafter, referred to as a sheet material P), which is an object on which an image is formed, is arranged under the cartridge B.

In addition, the main body A includes a pickup roller 5a, a feed roller pair 5b, a conveyance roller pair 5c, a transfer guide 6, a transfer roller 7, a conveyance guide 8, a fixing device 9, a discharge roller pair 10, and a discharge tray 11 arranged in this order in a direction of conveyance D of the sheet material P. The fixing device 9 includes a heating roller 9a and a pressure roller 9b.

### Image Forming Process

Next, the image forming process is described schematically. On the basis of a print start signal, the electrophotographic photosensitive drum (hereinafter, referred to as a drum 62) is driven to rotate at a predetermined circumferential velocity (process speed) in a direction indicated by an arrow R.

A charging roller 66, to which a bias voltage is applied, comes into contact with an outer peripheral surface of the drum 62 and charges an outer peripheral surface of the drum 62 uniformly and evenly.

The exposure device 3 outputs a laser beam L in accordance with image information. The laser beam L passes through a laser opening 71h provided in a cleaning frame 71 of the cartridge B and scans and exposes the outer peripheral surface of the drum 62. Accordingly, an electrostatic latent image corresponding to the image information is formed on the outer peripheral surface of the drum 62.

In contrast, as illustrated in FIG. 3, in a first unit as a developing device (hereinafter, referred to as a developing unit 20), toner T in a toner chamber 29 is stirred and conveyed by rotation of a first conveyance member 43, second conveyance member 44, and a third conveyance member 50 and is delivered to a toner supply chamber 28.

The toner T is born on a surface of a developing roller 32 by a magnetic force of a magnet roller 34 (fixed magnet).

The toner T on a peripheral surface of the developing roller 32 is controlled in thickness and, simultaneously, is frictionally charged by a developing blade 42.

The toner T is developed on the drum 62 in accordance with the electrostatic latent image and is visualized as a toner image. In other words, the developing roller 32 is a developer bearing member configured to bear a developer thereon and develop a latent image (electrostatic latent image). The drum 62 is an image bearing member on which latent images are formed and toner images (a developer image) are born.

As illustrated in FIG. 2, the sheet material P stored in a lower portion of the main body A is fed from the sheet tray 4 by the pickup roller 5a, the feed roller pair 5b, and the conveyance roller pair 5c at the same timing as outputting of the laser beam L. Then, the sheet material P passes through the transfer guide 6 and is fed to a transfer position between the drum 62 and the transfer roller 7. At this transfer position, toner images are transferred sequentially from the drum 62 to the sheet materials P.

The sheet material P to which the toner image is transferred is separated from the drum 62 and conveyed to the fixing device 9 along the conveyance guide 8. The sheet material P then passes through a nip portion between the heating roller 9a and the pressure roller 9b which constitute the fixing device 9. At the nip portion, pressurization and heat-fixation are performed, so that the toner image is fixed to the sheet material P. The sheet material P subjected to the fixation of the toner image is conveyed to the discharge roller pair 10 and is discharged to the discharge tray 11.

In contrast, as illustrated in FIG. 3, residual toner on the outer peripheral surface of the drum 62 after the transfer is removed by a cleaning blade 77, and the drum 62 is used for the image forming process again. The toner removed from the drum 62 is stored in a waste toner chamber 71b of a second unit (hereinafter referred to as a cleaning unit 60). The cleaning unit 60 is arranged in a vertical direction over a developing unit (first unit) 20. In other words, the developing unit 20 is arranged under the cleaning unit 60.

In the description given above, the charging roller 66, the developing roller 32, the transfer roller 7, and the cleaning blade 77 correspond to process devices configured to act on the drum 62.

### Mounting and Demounting of Cartridge

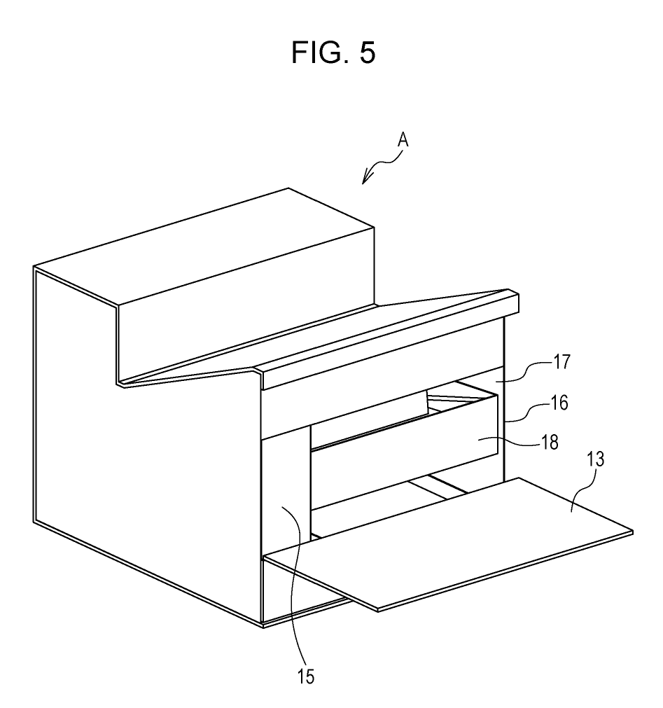

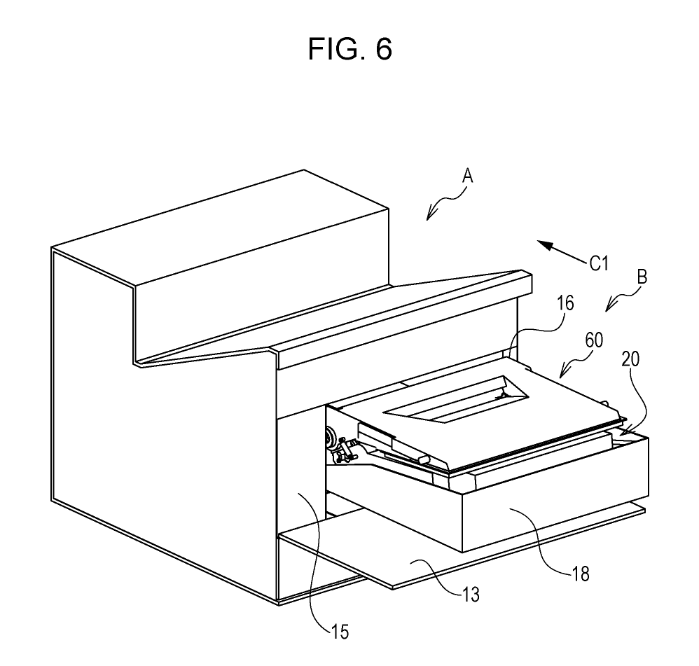

Mounting and demounting of the cartridge B with respect to the main body A will be described below with reference to FIG. 5 and FIG. 6.

FIG. 5 is a perspective view of the main body A in a state in which an opening and closing door 13 is opened for mounting and demounting the cartridge B. FIG. 6 is a perspective view of the main body A and the cartridge B in a state in which the opening and closing door 13 is opened and the tray 18 is pulled out for mounting and demounting the cartridge B.

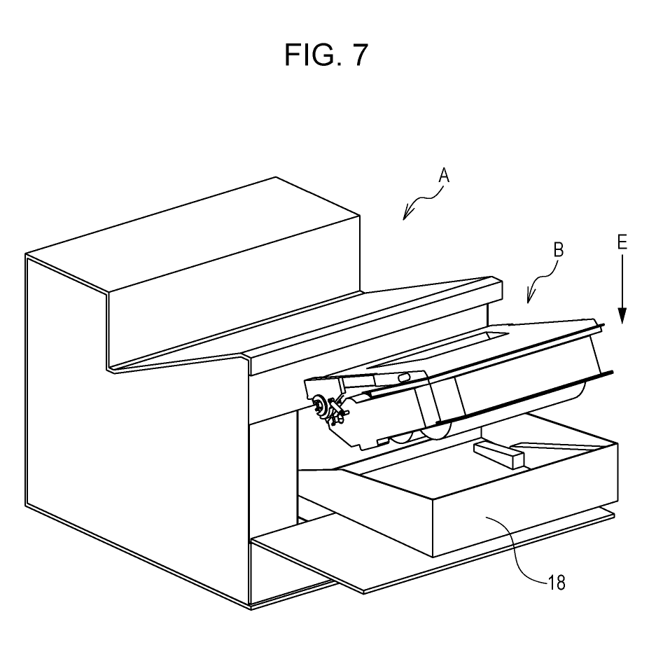

FIG. 7 is a perspective view of the main body A and the cartridge B when mounting and demounting the cartridge B in a state in which the opening and closing door 13 is opened and the tray 18 is pulled out. The cartridge B is demountably mountable with respect to the tray 18 in a mounting direction E.

The opening and closing door 13 is pivotable with respect to the main body A. When the opening and closing door 13 is opened, a cartridge insertion port 17 is provided. The tray 18 for mounting the cartridge B on the main body A is provided in the cartridge insertion port 17.

The tray 18 is a cartridge supporting member configured to support the cartridge B, and the cartridge B is mounted on the tray 18. In other words, when the tray 18 is pulled out to a predetermined position, mounting and demounting of the cartridge B is enabled. FIG. 6 illustrates a state in which the tray 18 is pulled out to an exterior of main body A (moved to the exterior). In other words, FIG. 6 illustrates a state in which the tray 18 is at a mounting and demounting position (exterior position) for mounting and demounting the cartridge B.

The cartridge B is mounted in the interior of the main body A along a guide rail (not illustrated) in a direction of an arrow C1 (in a first direction) in the drawing in a state of being mounted on the tray 18.

FIG. 5 and FIG. 2 illustrate a state in which the tray 18 is mounted in the interior of the main body A. At this time, the cartridge B mounted on the tray 18 is supported by the main body A and is arranged at a position which enables image formation. In other words, FIG. 5 and FIG. 2 illustrate a state in which the tray 18 is located within the main body A at an image forming position (internal position) which allows the cartridge B to form an image.

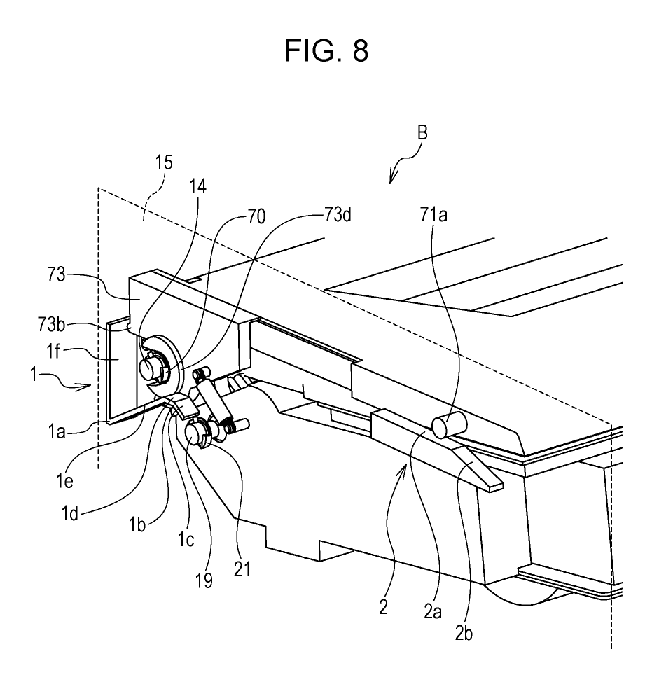

In addition, a first drive shaft 14 and a second drive shaft 19 configured to transmit respective drive forces to a first coupling 70 and a second coupling 21 (FIG. 8) provided on the cartridge B are provided. The first drive shaft 14 and the second drive shaft 19 are driven by a motor (not illustrated) of the main body A. Accordingly, the drum 62 coupled to the first coupling 70 receives a drive force from the main body A and rotates. The developing roller 32 rotates upon reception of a drive source from the second coupling 21. The charging roller 66 and the developing roller 32 receive a supply of electricity from a power feeding unit (not illustrated) of the main body A.

### Supporting of Cartridge

As illustrated in FIG. 5, the main body A is provided with a drive-side panel 15 and a non-drive-side panel 16 for supporting the cartridge B. As illustrated in FIG. 8, the drive-side panel 15 is provided with a drive-side supporting portion 1 and a drive-side rotation-restricting portion 2 for supporting the cartridge B.

The drive-side supporting portion 1 includes a supporting portion 1a and a first guide portion (first body-side guide portion) 1b formed integrally with each other. The drive-side rotation-restricting portion 2 includes a rotation restricting surface 2a and a second guide portion (second body-side guide portion) 2b formed integrally with each other. The supporting portion 1a includes supporting surfaces 1f and 1e. The first guide portion 1b includes guide surfaces 1c and 1d.

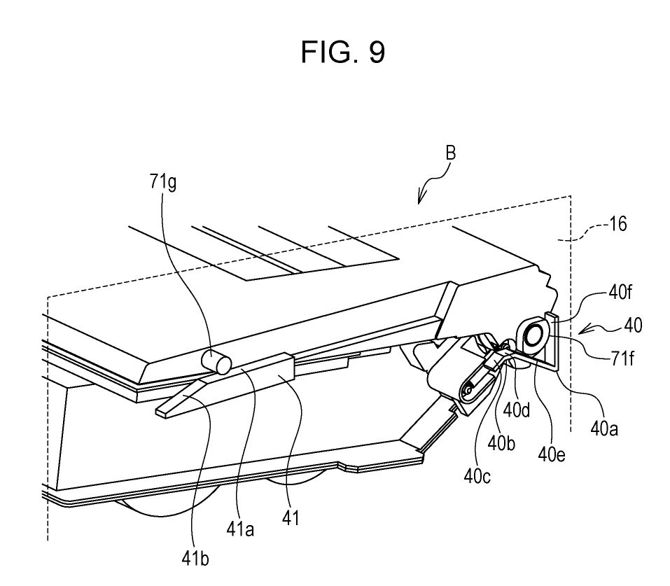

In the same manner, as illustrated in FIG. 9, a non-drive-side supporting portion 40 and a non-drive-side rotation-restricting portion 41 are provided in the non-drive-side panel 16. The non-drive-side supporting portion 40 includes a supporting portion 40a and a first guide portion (first body-side guide portion) 40b formed integrally with each other. The non-drive-side rotation-restricting portion 41 includes a rotation restricting surface 41a and a second guide portion (second body-side guide portion) 41b formed integrally with each other. The supporting portion 40a includes a supporting surface 40f and a supporting surface 40e. The first guide portion 40b includes guide surfaces 40c and 40d.

In contrast, supported portions of the cartridge B include a supported portion 73b, a supported portion 73d of a drum bearing 73, and a non-drive-side projecting portion 71f.

The cleaning unit 60 includes a drive-side boss 71a and a non-drive-side boss 71g as rotation-restricted portions.

The supported portion 73b and the supported portion 73d are supported by the supporting surface 1f and the supporting surface 1e, respectively.

The drive-side boss 71a is supported by the rotation restricting surface 2a. In the same manner, the non-drive-side projecting portion (supported portion) 71f is supported by a non-drive-side first supporting portion 40f and a non-drive-side second supporting portion 40e. The non-drive-side boss 71g is supported by the rotation restricting surface 41a. In this configuration, the cartridge B is positioned within the main body A.

In other words, the supported portions (the supported portions 73b and 73d and a projecting portion 71f) of the cartridge B are supported by supporting portions (supporting portions 1a and 40a) of the main body A. Accordingly, the drum 62 (FIG. 2) of the cartridge B is positioned at a position where image formation is enabled. In this state, the rotation-restricted portions of the cartridge B (the drive-side boss 71a, the non-drive-side boss 71g) come into contact with rotation-restricting portions 2, 41 of the main body A. Therefore, rotation of the cartridge B about the supporting portions (supporting portions 1a and 40a) as supporting points (center) is also restricted. The posture of the cartridge is retained, and positioning of the entire part of the cartridge B is achieved.

### Configuration of Cartridge as a Whole

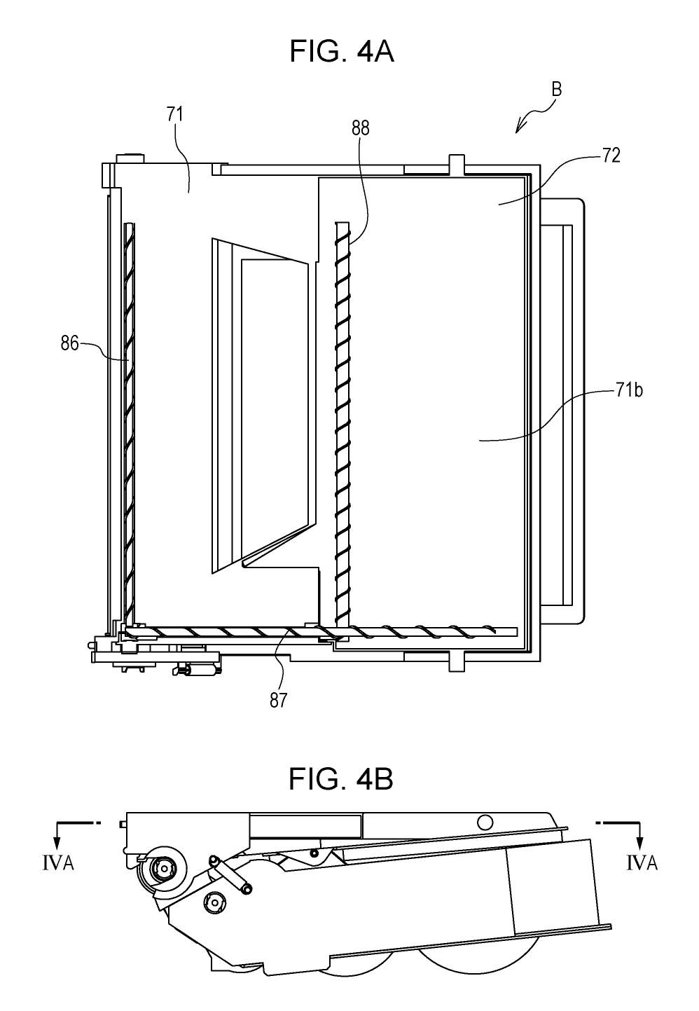

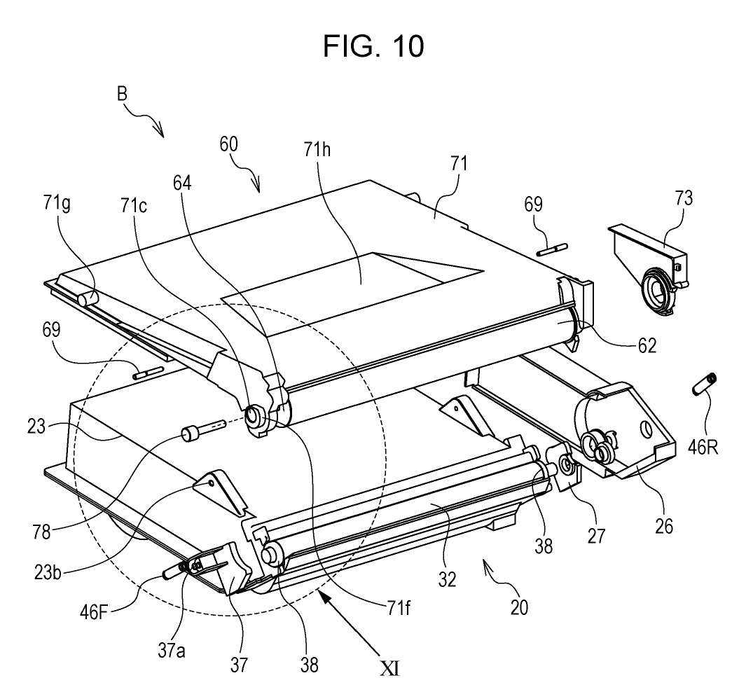

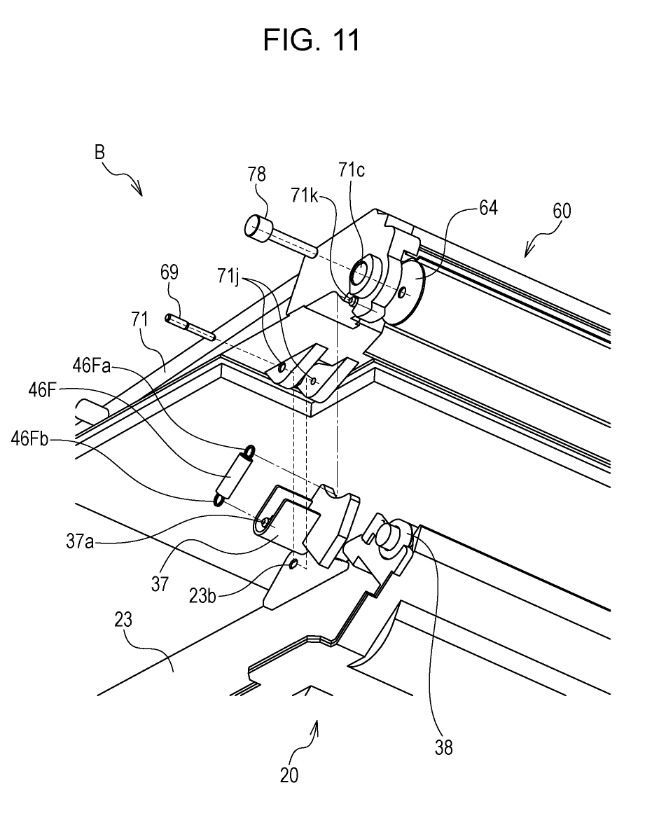

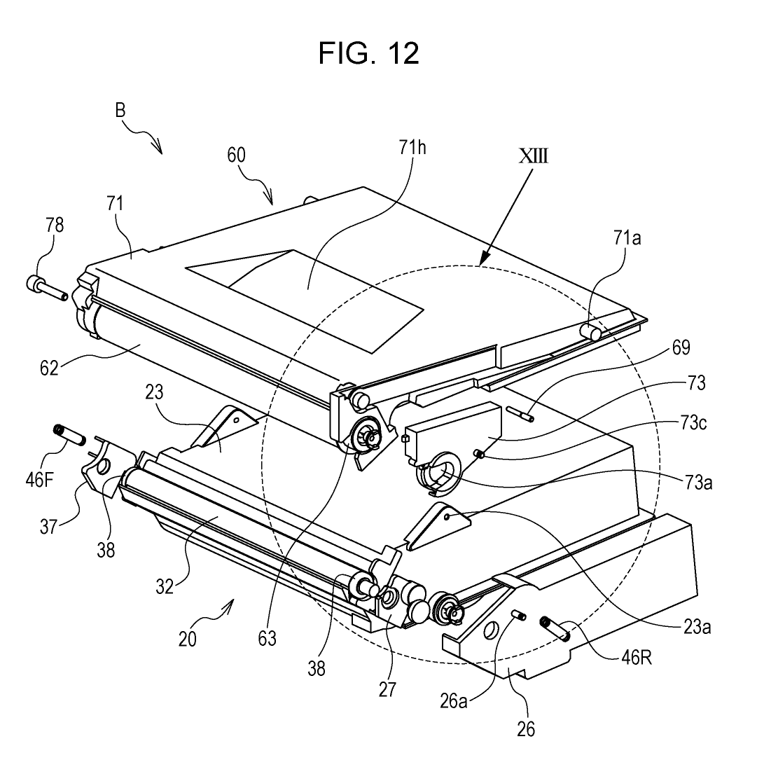

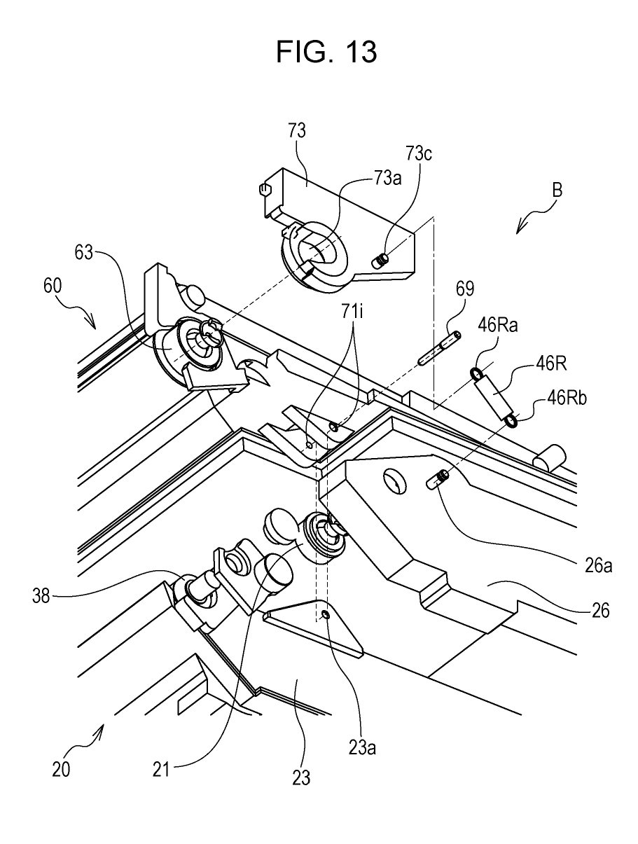

A general configuration of the cartridge B will be described with reference to FIG. 3, FIGS. 4A and 4B, FIG. 10, FIG. 11, FIG. 12, and FIG. 13 below. FIG. 3 is a cross-sectional view of the cartridge B, FIG. 10, FIG. 11, FIG. 12, and FIG. 13 are perspective views for explaining a configuration of the cartridge B. FIG. 11 and FIG. 13 are partly enlarged drawings illustrating portions within dot lines XI, XIII in FIG. 10 and FIG. 12 viewed from a different angle in an enlarged scale. In this example, a description of screws used for coupling components is omitted.

The cartridge B includes the cleaning unit 60 and the developing unit 20. In general, the process cartridge includes an electrophotographic photosensitive member and at least one of a charging device, a developing device, and a cleaning device as process devices configured to act integrally on the electrophotographic photosensitive member to form a cartridge so as to be mountable on and demountable from the main body of the electrophotographic image forming apparatus.

As illustrated in FIG. 3, the cleaning unit 60 includes the drum 62, the charging roller 66, a cleaning member 77, the cleaning frame 71 configured to support these members, and a lid member 72 fixed to the cleaning frame 71 by welding or the like. In the cleaning unit 60, the charging roller 66 and the cleaning member 77 are arranged to be in contact with an outer peripheral surface of the drum 62.

The cleaning member 77 includes a rubber blade 77a, which is a blade-shaped resilient member formed of rubber as a resilient material, and a supporting member 77b configured to support the rubber blade 77a. The rubber blade 77a is in contact with the drum 62 in a counter direction with respect to the direction of rotation of the drum 62. In other words, the rubber blade 77a is in contact with the drum 62 so that a distal end portion thereof faces upstream of the direction of rotation of the drum 62.

FIG. 4A is a cross-sectional view illustrating an interior of the cleaning frame 71. As illustrated in FIG. 3 and FIG. 4A, waste toner removed from the surface of the drum 62 by the cleaning member 77 is conveyed by a first screw 86, a second screw 87, and a third screw 88 as waste toner conveyance members. The conveyed toner is accumulated in the waste toner chamber 71b formed by the cleaning frame and the lid member. The first screw 86 is rotated by a gear (not illustrated) upon transmission of a drive force from the coupling 21 illustrated in FIG. 13. The second screw 87 is rotated by a drive force from the first screw 86, and the third screw 88 is rotated by a drive force from the second screw 87. The first screw 86 is arranged in the vicinity of the drum 62, the second screw 87 is arranged at an end portion in the longitudinal direction of the cleaning frame 71, and the third screw 88 is arranged in the waste toner chamber 71b. Here, the rotation axes of the first screw 86 and the third screw 88 are parallel to a rotation axis of the drum 62, and a rotation axis of the second screw 87 is orthogonal to the rotation axis of the drum 62.

As illustrated in FIG. 3, a scooping sheet 65 for preventing waste toner from leaking out from the cleaning frame 71 is provided at an edge portion of the cleaning frame 71 so as to come into contact with the drum 62.

The drum 62 receives a drive force from a main body drive motor (not illustrated) as a drive source and is rotated thereby in a direction indicated by the arrow R in the drawing in accordance with an image forming action.

The charging roller 66 is rotatably mounted on the cleaning unit 60 via a charging roller bearing 67 at both end portions in a longitudinal direction of the cleaning frame 71 (substantially parallel to the direction of an axis of rotation of the drum 62). The charging roller 66 is in press contact with the drum 62 by the charging roller bearing 67 which is pressed by a biasing member 68 toward the drum 62. The charging roller 66 is rotated by the rotation of the drum 62.

As illustrated in FIG. 3, the developing unit 20 includes the developing roller 32, a developer container 23 configured to support the developing roller 32, and the developing blade 42. The magnet roller 34 is provided in the developing roller 32. The developing blade 42 for controlling the toner layer on the developing roller 32 is arranged in the developing unit 20. As illustrated in FIG. 10 and FIG. 12, the developing roller 32 includes distance retaining members 38 mounted on both end portions of the developing roller 32, and the distance retaining members 38 come into contact with the drum 62, so that the developing roller 32 is retained apart from the drum 62 with small gaps therebetween. As illustrated in FIG. 3, a blow-out preventing sheet 33 for preventing toner from leaking out from the developing unit 20 is provided at an edge portion of a bottom member 22 so as to come into contact with the developing roller 32. In addition, the first conveyance member 43, the second conveyance member 44, and the third conveyance member 50 are provided in the toner chamber 29 formed by the developer container 23 and the bottom member 22. The first conveyance member 43, the second conveyance member 44, and the third conveyance member 50 stir toner stored in the toner chamber 29, and convey the toner to the toner supply chamber 28.

As illustrated in FIG. 10 and FIG. 12, the cartridge B includes the cleaning unit 60 and the developing unit 20 combined with each other.

The cleaning unit 60 includes the cleaning frame 71, the lid member 72, the drum 62, the drum bearing 73 configured to rotatably support the drum 62, and a drum shaft 78. As illustrated in FIG. 13, on the drive-side, the drum 62 is rotatably supported by a drive-side drum flange 63 provided on the drive-side fitted in a hole portion 73a of the drum bearing 73. In contrast, as illustrated in FIG. 11, on the non-drive-side, the drum shaft 78 press-fitted into a hole portion 71c provided in the cleaning frame 71 rotatably supports the hole portion (not illustrated) of a non-drive-side drum flange 64.

In contrast, as illustrated in FIG. 3, FIG. 10, and FIG. 12, the developing unit 20 includes the bottom member 22, the developer container 23, a drive-side development side member 26, the developing blade 42, and the developing roller 32. The developing roller 32 is rotatably mounted on the developer container 23 by bearing members 27 and 37 provided at both ends thereof.

As illustrated in FIG. 11 and FIG. 13, the cleaning unit 60 and the developing unit 20 are pivotably coupled to each other by coupling pins 69 to constitute part of the cartridge B. The developing unit 20 is pivotable with respect to the cleaning unit 60 about the coupling pins 69.

Specifically, a first supporting hole 23a and a second supporting hole 23b are provided in the developer container 23 at both end portions in the longitudinal direction of the developing unit 20. A first hanging holes 71i and a second hanging holes 71j are provided in the cleaning frame 71 at both end portions in the longitudinal direction of the cleaning unit 60. The coupling pins 69 fixedly press-fitted to the first hanging holes 71i and the second hanging holes 71j are fitted into the first supporting hole 23a and the second supporting hole 23b, so that the cleaning unit 60 and the developing unit 20 are coupled pivotably with respect to each other.

A first hole portion 46Ra of a drive-side biasing member 46R is hooked on a boss 73c of the drum bearing 73, and a second hole portion 46Rb is hooked on a boss 26a of the drive-side development side member 26.

A first hole portion 46Fa of a non-drive-side biasing member 46F is hooked on a boss 71k of the cleaning frame 71 and a second hole portion 46Fb is hooked on a boss 37a of a bearing member 37.

In this example, the drive-side biasing member 46R and the non-drive-side biasing member 46F are each formed of a tension coil. With biasing forces of these springs, the developing unit 20 is biased toward the cleaning unit 60, thereby reliably pressing the developing roller 32 against the drum 62. With distance retaining members 38 mounted on both end portions of the developing roller 32, the developing roller 32 is retained at a predetermined distance from the drum 62.

Mounting and Demounting of Cartridge with Respect to Tray

As described above, mounting and demounting of the cartridge B with respect to the main body A is performed in a state in which the cartridge B is mounted on the tray 18.

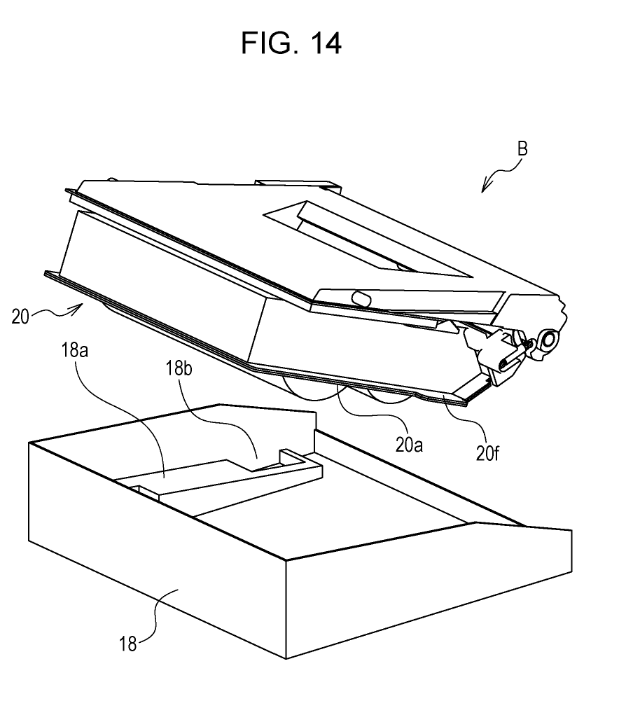

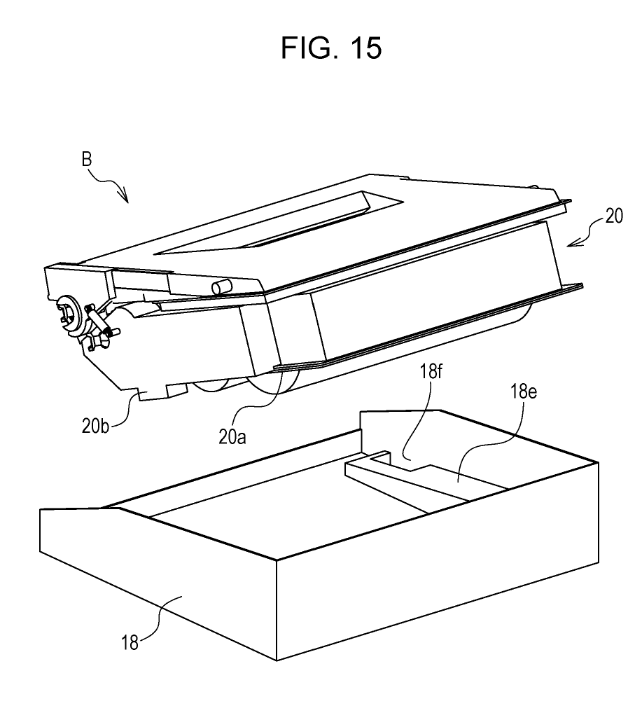

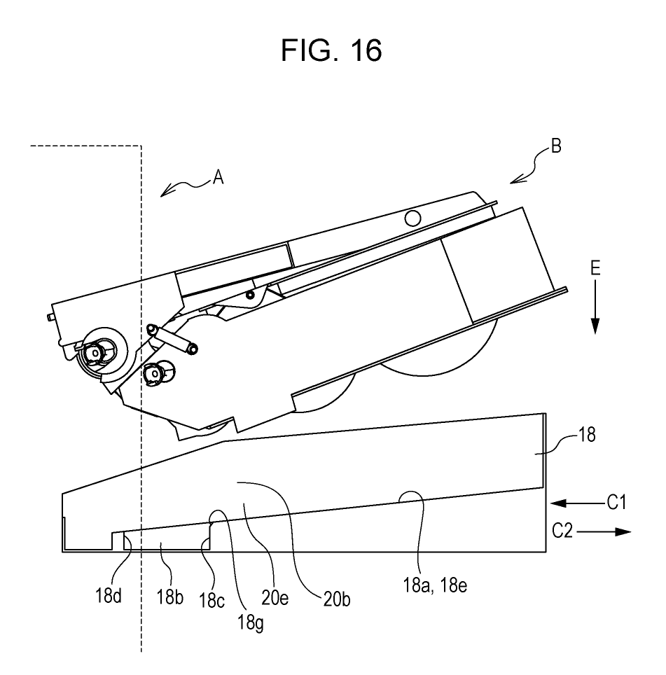

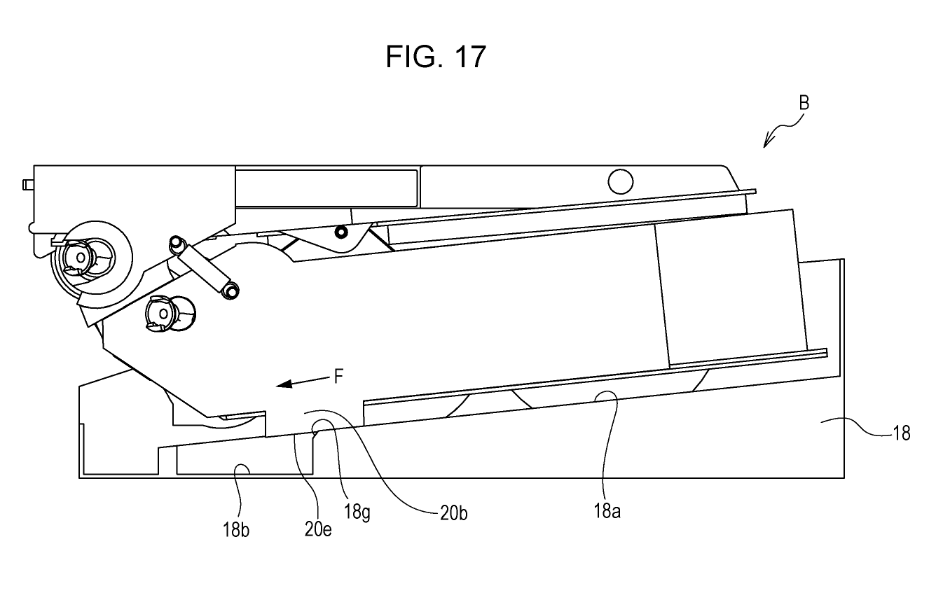

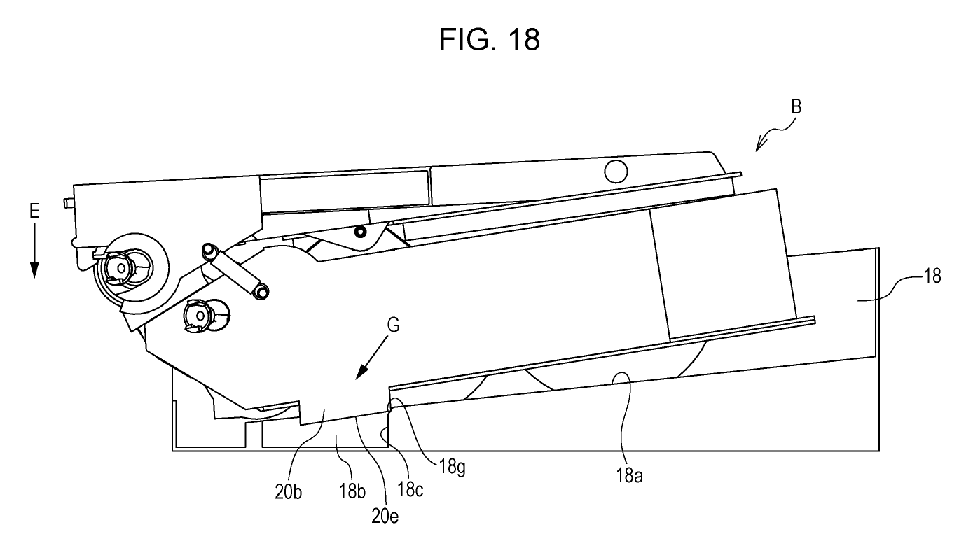

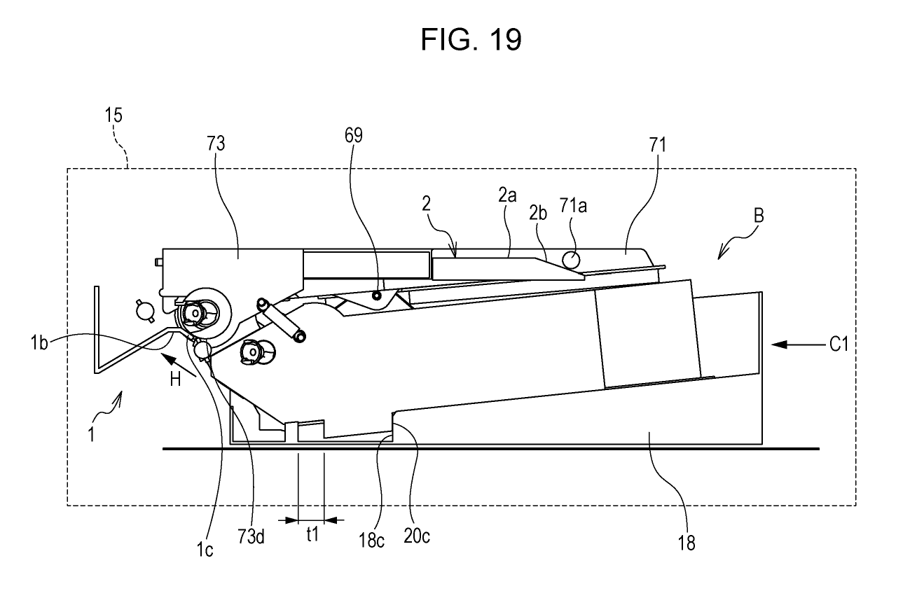

Mounting and demounting of the cartridge B with respect to the tray 18 will be described. FIG. 14 and FIG. 15 are perspective views illustrating components of the cartridge B and the tray 18. FIG. 16, FIG. 17, FIG. 18, and FIG. 19 are schematic illustrations of a positional relationship between the cartridge B and the tray 18 at the time of mounting and demounting illustrated in chronological order.

A configuration of the tray 18 will be described in detail with reference to FIG. 14, FIG. 15, and FIG. 16. The tray 18 is provided with supporting surfaces 18a and 18e configured to support a supported surface 20a provided on the developing unit 20. The supporting surfaces 18a and 18e are configured to be inclined downward toward the downstream side in a direction of tray insertion C1 as illustrated in FIG. 16. As illustrated in FIG. 14 and FIG. 15, the tray 18 is provided with position restricting portions 18b and 18f configured to engage position-restricted portions 20b and 20f disposed on a bottom surface of the developing unit 20. The position restricting portions 18b and 18f are configured to suppress the movement of the cartridge B with respect to the tray 18 in a direction indicated by an arrow C1 in FIG. 16 (first direction) and a direction (second direction) C2 of pulling out of the tray in FIG. 16 (restricts the movement).

The position restricting portion 18b includes a first contact surface 18c and a second contact surface 18d. A portion between the first contact surface 18c and the second contact surface 18d corresponds to a space that the position-restricted portion 20b enters (opening portion or groove portion).

The function of the position restricting portion 18f is the same as that of the position restricting portion 18b. In this example, only the position restricting portion 18b projects downward. However, any of the position restricting portions 18b and 18f may project downward as long as at least one of these position restricting portions projects downward. Mounting and demounting of the cartridge B with respect to the tray 18 will be described next with reference to FIG. 16, FIG. 17, and FIG. 18. Configurations of the tray 18 and the developing unit 20 described above are provided on both end portions in the longitudinal direction. However, only those on the drive-side will be described below because these members function the same on both sides.

FIG. 16 illustrates a state in which the opening and closing door 13 (see FIG. 6) is opened, the tray 18 is pulled out from the image forming position and is at a mounting and demounting position at which the cartridge B can be mounted and demounted with respect to the tray 18. In FIG. 16, when a user grips a grip, which is not illustrated, and mounts the cartridge B on the tray 18 in a direction indicated by an arrow E in FIG. 16, a bottom surface 20e of the position-restricted portion 20b comes into contact with the supporting surface 18a as illustrated in FIG. 17. At this time, the supporting surface 18a is inclined, and the user is allowed to move the cartridge B in a direction indicated by an arrow F in FIG. 17 in a state in which the position-restricted portion 20b is in contact with the supporting surface 18a.

In other words, the supporting surface 18a is a guide (supporting-member-side guide portion) configured to come into contact with the position-restricted portion 20b to guide the cartridge B to be mounted on the tray 18.

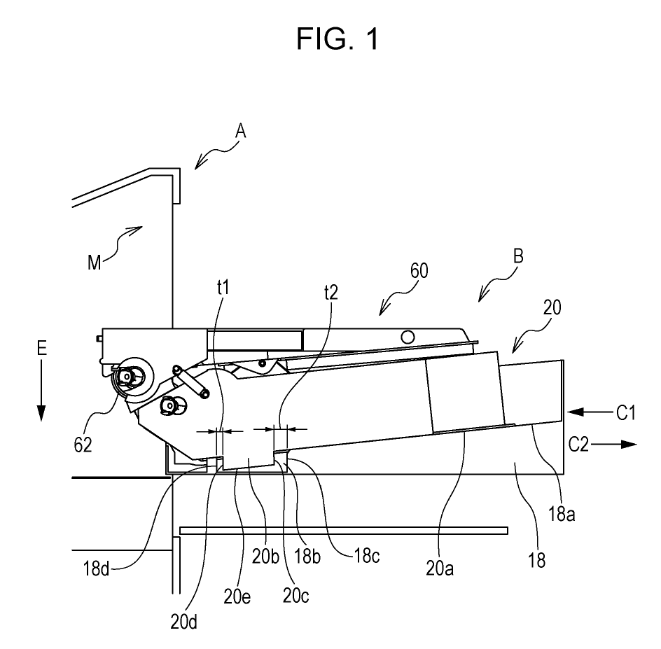

When the cartridge B is moved along the supporting surface 18a in the direction indicated by the arrow F by a certain extent or more, the bottom surface 20e of the position-restricted portion 20b comes out of contact with the supporting surface 18a and comes into contact with an inclined surface 18g as illustrated in FIG. 18. The inclination of the inclined surface 18g is larger than the inclination of the supporting surface 18a, and is an inclination which allows the position-restricted portion 20b to slide downward with respect to the inclined surface 18g under the weight of the cartridge B when the bottom surface 20e comes into contact therewith. Therefore, in the state illustrated in FIG. 18, the cartridge B moves in a direction indicated by an arrow G along the inclined surface 18g. Since there is a step between the inclined surface 18g and the position restricting portion 18b, the cartridge B moves in a direction E under its own weight after the bottom surface 20e and the inclined surface 18g have come out of contact with each other. After the movement in the direction E, the position-restricted portion 20b of the cartridge B is positioned at the position restricting portion 18b, and the supported surface 20a is supported by the supporting surface 18a, so that mounting of the cartridge B on the tray 18 is completed as illustrated in FIG. 1.

When mounting the cartridge B on the tray 18, the user is allowed to mount the cartridge B on the tray 18 smoothly owing to the provision of the supporting surface 18a and the inclined surface 18g. In other words, the supporting surface 18a and the inclined surface 18g are inclined surface extending downward in the direction of mounting of the cartridge B on the tray 18. The user is allowed to mount the cartridge B on the tray 18 by utilizing the weight of the cartridge B.

This example has a configuration in which when the cartridge B is mounted on the tray 18, part (distal end side) of the cartridge B enters the interior of the main body A (see FIG. 6 and FIG. 1). The distal end portion of the cartridge B can be entered in the interior of the main body A and hence can be mounted easily as long as the cartridge B can be mounted on the tray 18 obliquely downward (in the direction indicated by the arrow F) along the supporting surface 18a and the inclined surface 18g.

In this configuration, the position-restricted portion 20b, which corresponds to a projecting portion, is provided on the cartridge B, and the position restricting portion 18b, which corresponds to a notched portion, is provided on the main body A. The cartridge B moves in a direction indicated by the arrow F in FIG. 17 with respect to the tray 18 in a state in which the bottom surface 20e of the position-restricted portion 20b is in contact with the supporting surface 18a and moves in the direction indicated by the arrow G in FIG. 18 in a state in which the bottom surface 20e of the position-restricted portion 20b is in contact with the inclined surface 18g. Finally, the cartridge B moves in a direction indicated by an arrow E in FIG. 18 under its own weight and a mounted state in which the cartridge B is restricted in position with respect to the tray 18 is achieved.

In other words, the supporting surface 18a and the inclined surface 18g not only guide mounting of the cartridge, but also guide the position-restricted portion 20b to the position restricting portion 18b as a guide (supporting-member-side guide portion). Accordingly, mounting of the cartridge B on the tray 18 and positional restriction of the cartridge B by the position restricting portion 18b and the position-restricted portion 20b are smoothly achieved.

The user does not have to lift the cartridge B in the course of mounting the cartridge B on the tray 18. In contrast to this example, a configuration in which the position-restricted portion 20b is in the form of a notch and the position restricting portion 18b is in the form of a projecting portion is also applicable. In this case, however, since the position restricting portion 18b, which is a projecting portion, exists in the direction of mounting of the position-restricted portion 20b, the user needs to lift the cartridge B when mounting the cartridge B.

Therefore, in the configuration of this example, the user is allowed to mount the cartridge B more smoothly without necessity of lifting the cartridge B for mounting compared with the case where the projecting shape and the notched portion of the position-restricted portion 20b and the position restricting portion 18b are provided vice versa.

The tray 18 is configured to have a reduced pulling-out amount from the main body A within a range which does not affect demounting of the cartridge B. Specifically, as illustrated in FIG. 1, the drum 62 of the cartridge B is arranged in the main body A at a cartridge mounting and demounting position. Therefore, in a state in which the tray 18 having the cartridge B mounted thereon is at the cartridge mounting and demounting position, the center of gravity of the image forming apparatus is prevented from significantly deviating from the center of gravity of the main body A, so that the main body A is prevented from falling down.

In contrast, as illustrated in FIG. 1, the cartridge B may be demounted from the tray 18 by moving the cartridge B in a direction indicated by an arrow M in FIG. 1 in a state in which the tray 18 is demounted from the main body A in a direction indicated by an arrow C2 and the tray 18 is arranged in the mounting and demounting position.

### Mounting and Demounting of Cartridge to Main Body of the Apparatus

Mounting and demounting of the cartridge B with respect to the main body A will be described below. As described above, the main body A is provided with the drive-side supporting portion 1 and the drive-side rotation-restricting portion 2 on the drive-side panel 15 as illustrated in FIG. 8, and the non-drive-side supporting portion 40 and the non-drive-side side rotation-restricting portion 41 are provided on the non-drive-side panel 16 as illustrated in FIG. 9. Since these members function the same on both sides, only a configuration on the drive-side will be described below.

FIG. 1 is a drawing illustrating a state in which the cartridge B is mounted on the tray 18. The supporting surface 18a of the tray 18 comes into contact with the supported surface 20a, and hence a state in which the cartridge B is supported by the tray 18 is achieved.

The position-restricted portion 20b provided on a bottom surface of the developing unit 20 includes a first contacted surface 20c and a second contacted surface 20d. When the cartridge B is mounted on the tray 18, a gap t1 exists between the first contact surface 18c and the first contacted surface 20c, and a gap t2 exists between the second contact surface 18d and the second contacted surface 20d. Therefore, the cartridge B is movable in the direction indicated by the arrow C1 by an amount corresponding to the gap t1, and is movable in the direction indicated by the arrow C2 by an amount corresponding to the gap t2 with respect to the tray 18.

In other words, the position restricting portion 18b engages the position-restricted portion 20b, so that a range in which the cartridge B is movable with respect to the tray 18 is restricted within a range of a gap (t1+t2).

Mounting of the cartridge B on the main body A will be described first.

When the tray 18 is pressed in the direction indicated by the arrow C1 in FIG. 1, the gap t2 disappears, the first contact surface 18c provided on the tray 18 and the first contacted surface 20c come into contact, and the process cartridge B moves in the direction indicated by the arrow C1 in FIG. 1 by a force from the tray 18.

As illustrated in FIG. 19, a supported portion 73d of the drum bearing 73 and the drive-side boss 71a of the cleaning frame 71 come into contact with a guide surface 1c and a guide portion 2b and a guide portion 2b provided on the drive-side supporting portion 1 and the drive-side rotation-restricting portion 2. The guide surface 1c and /the guide portion 2b are surfaces substantially parallel to each other and are inclined with respect to the direction indicated by an arrow C1, so that the cartridge B can be guided in a direction indicated by an arrow H.

Since the first contact surface 18c and the first contacted surface 20c are in contact with each other, if the tray 18 is moved in the direction indicated by the arrow C1 in FIG. 19, the tray 18 moves in the direction C1. At this time, the supported portion 73d and the drive-side boss 71a are guided by the guide surface 1c and the guide portion 2b, the cartridge B is moved relatively to the tray 18 in the direction indicated by the arrow H. As illustrated in FIG. 19, the direction indicated by the arrow H is a vector having at least a component of the direction indicated by the arrow C1. Therefore, the fact that the cartridge B moves in the direction indicated by the arrow H means that the cartridge B moves at least in the direction indicated by the arrow C1.

At this time, the position-restricted portion 20b engages the position restricting portion 18b, and the gap t1+t2 is provided between the position-restricted portion 20b and the position restricting portion 18b, so that no problem occurs in the movement of the cartridge B with respect to the tray 18.

The supported portion 73d and the drive-side boss 71a provided on the cartridge B come into contact with the guide surface 1c and the guide portion 2b provided on the main body A substantially simultaneously. In other words, the cartridge B starts to translate from the state of being supported by the tray 18 to the state supported by the main body A.

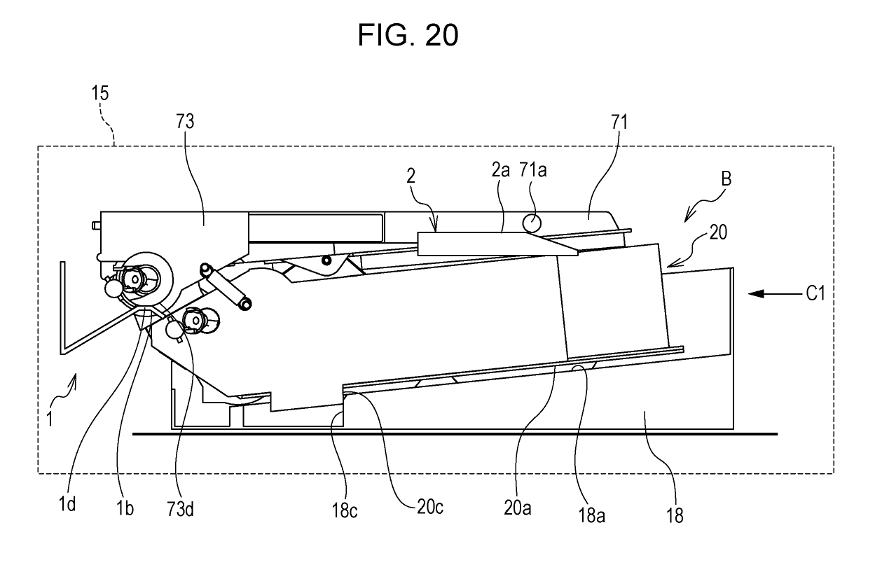

When the tray 18 is moved further in the direction indicated by an arrow C1, the supported portion 73d of the drum bearing 73 and the drive-side boss 71a of the cleaning frame 71 are supported by the guide surface 1d and the rotation restricting surface 2a provided on the drive-side supporting portion 1 and the drive-side rotation-restricting portion 2 as illustrated in FIG. 20.

At this time, the supported surface 20a provided on the developing unit 20 comes out of contact with the supporting surface 18a, and the process cartridge B is supported by a supporting surface 1d of the drive-side supporting portion 1 and the rotation restricting surface 2a of the drive-side rotation-restricting portion 2.

In contrast, since the first contact surface 18c and the first contacted surface 20c are maintained in a contacted state, if the user moves the tray 18 in a direction C1 in FIG. 20, the process cartridge B also moves in the direction indicated by the arrow C1 which is parallel to the supporting surface 1d and the rotation restricting surface 2a.

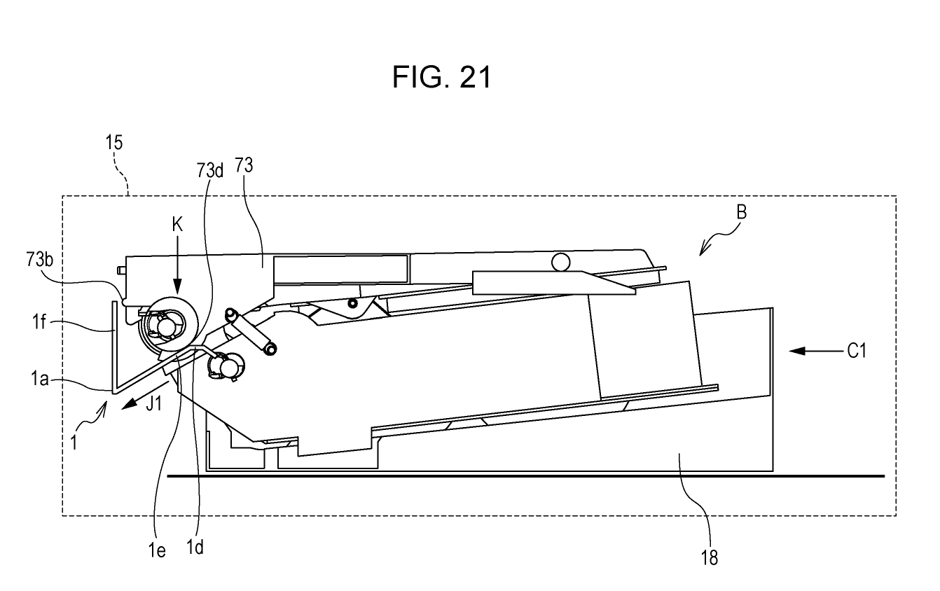

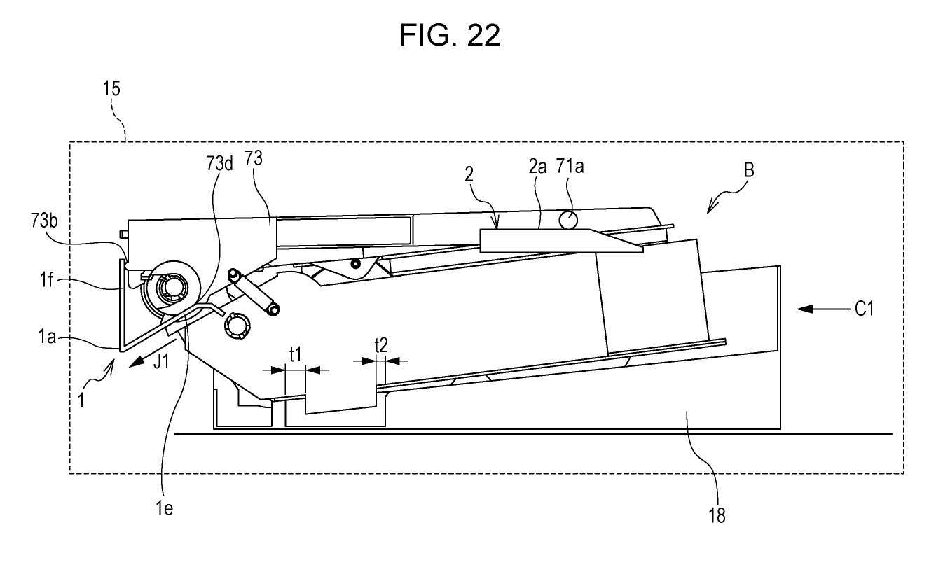

As illustrated in FIG. 21, the supported portion 73d of the drum bearing 73 is supported by the supporting surface 1e provided on the drive-side supporting portion 1. In this state, a spring, which is not illustrated, disposed on the main body A biases the supported portion 73d of the drum bearing 73 of the cartridge B in a direction indicated by an arrow K. Since the supporting surface 1e has an inclined surface shape which is inclined downward with respect to the direction C1, the process cartridge B moves in a direction indicated by an arrow J1 in FIG. 21 along the supporting surface 1e under its own weight and by a biasing force in the direction indicated by the arrow K. When the process cartridge B is moved by a predetermined amount, the supported portion 73b of the drum bearing 73 comes into contact with the supporting surface 1f of the supporting portion 1a, the supported portion 73d comes into contact with the supporting surface 1e of the supporting portion 1a, and the drive-side boss 71a comes into contact with the rotation restricting surface 2a as illustrated in FIG. 22. In this state, the process cartridge B is positioned within the main body A, and mounting on the main body A is completed. As illustrated in FIG. 21, the direction indicated by the arrow J1 is a vector having at least a component of the direction indicated by the arrow C1. Therefore, the fact that the cartridge B moves in the direction indicated by the arrow J1 means that the cartridge B moves at least in the direction indicated by the arrow C1.

In association with a series of processes described above, the cartridge B is translated from the state supported by the tray 18 to the state supported by the main body A. In other words, in association with the movement of the tray 18 from the mounting and demounting position to the image forming position, the cartridge B can be mounted on the main body A. The user is allowed to mount the cartridge B on the main body A in a state in which the posture of the cartridge B is stabilized by the tray 18.

The tray 18 does not have a configuration in which the cartridge B is completely positioned in the directions C1 and C2 in FIG. 1.

When the tray 18 is at the image forming position, the cartridge B is directly positioned with respect to the main body A, but not with respect to the tray 18.

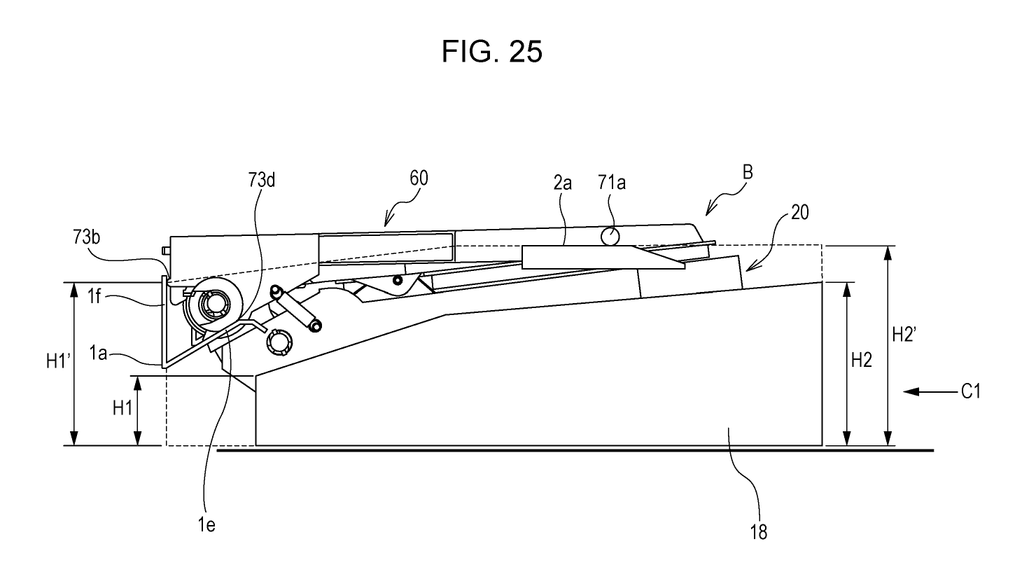

As illustrated in FIG. 25, in this configuration, the supported portion 73b, the supported portion 73d, and the drive-side boss 71a of the cleaning unit 60 of the cartridge B come into contact with the supporting portion 1a of the main body A and the rotation restricting surface 2a of the drive-side rotation-restricting portion 2, and hence the cartridge B is positioned with respect to the main body A.

Reference signs H1 and H2 are heights of the tray 18 on a downstream side and an upstream side in the direction of tray insertion C1 in this configuration. Reference sign H1′ is a height from a bottom surface of the tray 18 to a higher contact point between a contact point of the supported portion 73b with respect to the supporting portion 1a of the main body A and a contact point of the supported portion 73d with respect to the supporting portion la of the main body A. Reference sign H2′ is a height of a contact point between the drive-side boss 71a and the rotation restricting surface 2a from the bottom surface of the tray 18.

When an attempt is made to provide the tray 18 with a configuration for positioning the cartridge B, the tray 18 needs to have a configuration of supporting the supported portions 73b, 73d, and 71a. In this case, reference numeral H1 needs to be set to the same height as H1′ or larger, and the height of H2 needs to be set to the same height as H2′ or larger.

In contrast, in this configuration, the main body A, instead of the tray 18, is provided with the configuration for positioning the cartridge B, and hence setting the height H1 to be equal to or larger than the height H1′ and the height H2 to be larger than the height H2′ is not necessary. Therefore, the height H1 is smaller than H1′, and the height H2 is smaller than H2′.

Therefore, the height of the tray 18 may be relatively lower than the cartridge B, and hence the space of the tray 18 may be effectively utilized, so that a reduction in the size of the main body A is enabled.

In particular, in this example, the position of an upper end (the position having a height H2) of the tray 18 is lower than the contact position between the rotation restricted surface 71a and the rotation restricting surface 2a as illustrated in FIG. 25.

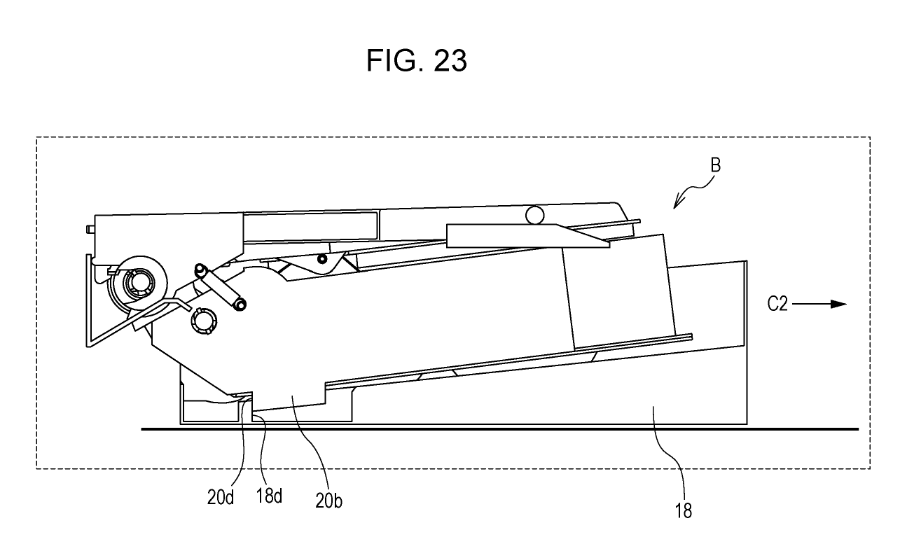

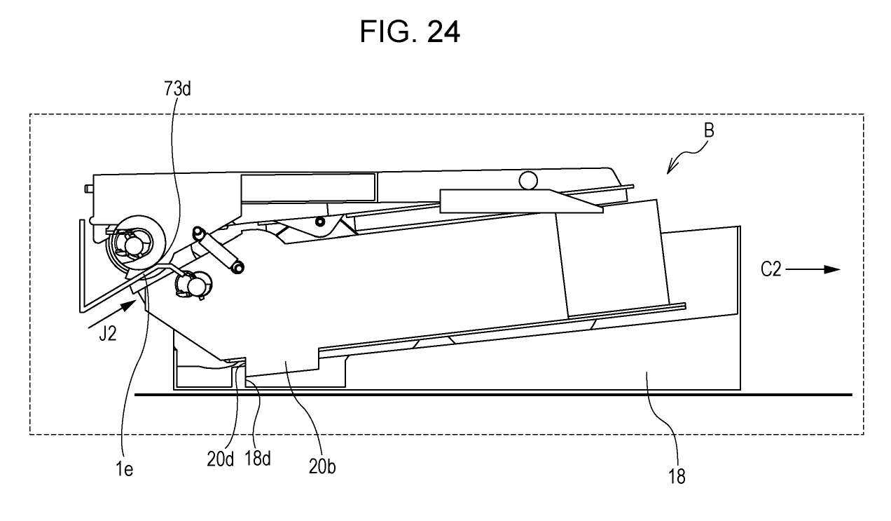

Subsequently, demounting of the cartridge B from the main body A will now be described. In a state in which mounting of the process cartridge B on the main body A is completed as illustrated in FIG. 22, gaps t1 and t2 are provided between the first contact surface 18c and the first contacted surface 20c and between the second contact surface 18d and the second contacted surface 20d. In this state, the cartridge B is in a state of being positioned by the supporting portion 1a and the rotation restricting surface 2a. Therefore, as illustrated in FIG. 23, when the tray 18 is moved in the direction indicated by an arrow C2 in FIG. 23, only the tray 18 is moved. In other words, the cartridge B is moved relatively in the opposite direction to the direction indicated by the arrow C2 with respect to the tray 18. Consequently, the gap t1 between the position-restricted portion 20b and the position restricting portion 18b (see FIG. 23) disappears and the second contact surface 18d comes into contact with the second contacted surface 20d. In addition, as illustrated in FIG. 24, the process cartridge B moves ongoingly in a direction indicated by an arrow J2 in FIG. 24 by the supporting portion 73d guided by the supporting surface 1e in association with the movement of the tray 18 in the direction C2. As illustrated in FIG. 21, the direction indicated by the arrow J2 is a vector having at least a component of the direction indicated by the arrow C2. Therefore, the fact that the cartridge B moves in the direction indicated by the arrow J2 means that the cartridge B moves at least in the direction indicated by the arrow C2.

When the tray 18 is moved in the direction indicated by the arrow C2 in FIG. 23 continuously, the cartridge B is translated from being supported by the drive-side supporting portion 1 and the drive-side rotation-restricting portion 2 to a state of being supported by the supporting surface 18a provided on the tray 18 in contrast to the case of being mounted.

In other words, the cartridge B is translated from the state of being supported by the main body A to the state of being supported by the tray 18 in association with the movement of the tray 18.

In addition, by moving the tray 18 further in the direction indicated by the arrow C2 in FIG. 23, the tray 18 is allowed to return to the cartridge mounting and demounting position illustrated in FIG. 1. In this state, the user grips the grip, which is not illustrated, from the mounting and demounting position and moves the cartridge B in the direction M, so that demounting of the cartridge B from the main body A is completed.

In conclusion, summary of the configuration of the example described thus far is as follows. A position-restricted portion 20b is provided on the developing unit 20 of the cartridge B as a mechanism for limiting the movement of the cartridge B with respect to the tray 18 within a certain range. The tray 18 is provided with position restricting portions 18b and 18f configured to engage the position-restricted portions 20b and 20f. Accordingly, the movement of the cartridge B with respect to the tray 18 is limited to the certain range, so that the cartridge B can be mounted and demounted with respect to the main body A only by moving the tray 18.

Here, the developing unit 20 is a unit positioned below the cleaning unit 60 in a state in which the cartridge is mounted on the tray 18. Therefore, the position-restricted portions 20b and 20f may be arranged at low positions in the cartridge B. The positions where the position restricting portions 18b and 18f are to be arranged in the tray 18 are also low. Consequently, the height of the tray 18 may be reduced as a whole, and the height of the main body A on which the tray 18 is mounted, that is, the height of the image forming apparatus is also reduced. A reduction in the size of the image forming apparatus is achieved.

The position-restricted portion 20b and the movement restricting portion 18b engage each other at a certain gap (t1+t2) interposed therebetween (see FIG. 1). Therefore, the movement of the cartridge B with respect to the tray 18 is limited, but a movement in a certain range, that is, an amount corresponding to the gap (t1+t2) is allowed. Therefore, when the tray 18 is moved to the image forming position (FIG. 2 and FIG. 5), the cartridge B moves the position-restricted portion 20b with respect to the movement restricting portion 18b to move relatively with respect to the tray 18. Accordingly, the cartridge B is smoothly translated from the state of being supported by the tray 18 to the state of being supported by the main body A.

The cartridge B is positioned with high degree of accuracy directly by the main body A by being supported by the main body A.

In the same manner, when the tray 18 moves toward the mounting and demounting position (FIG. 1 and FIG. 6), the cartridge B moves relatively with respect to the tray 18 while moving the position-restricted portion 20b with respect to the movement restricting portion 18b. Consequently, the cartridge B is smoothly translated from the state of being supported by the main body A to the state of being supported by the tray 18.

As described thus far, according to the example, since the position restricting portion 18b for the cartridge B is provided on the tray 18 and the positioning portion for the cartridge B is provided on the main body A, the height of the tray 18 can be reduced, and hence a reduction in the size of the tray 18 and the main body A is enabled.

### EXAMPLE 2

Next, a mode of Example 2 of this disclosure will be described. In Example 2, a portion different from Example 1 described above will be described in detail. The materials and the shapes are the same as those in Example described above unless otherwise described anew. Those parts are denoted by the same reference numerals, and detailed description will be omitted. In Example 2, the number and the positions of position-restricted portions and position restricting portions are modified.

### Mounting and Demounting of Cartridge to Tray

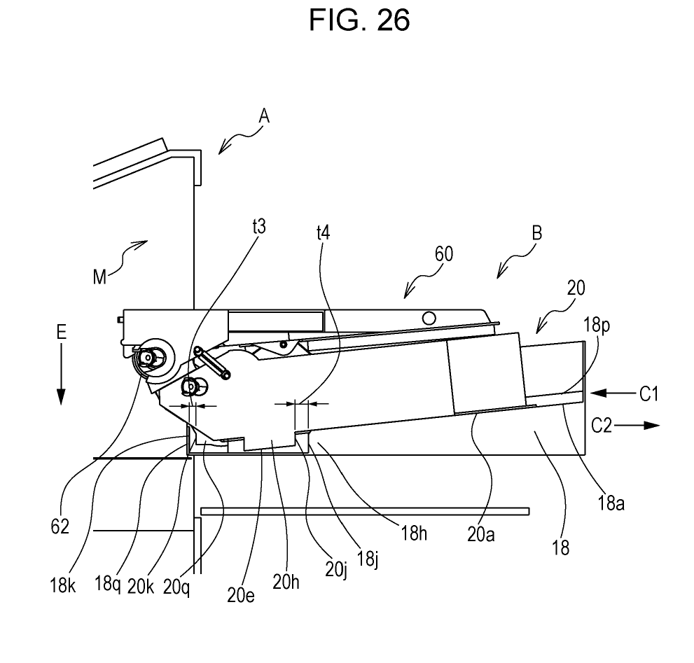

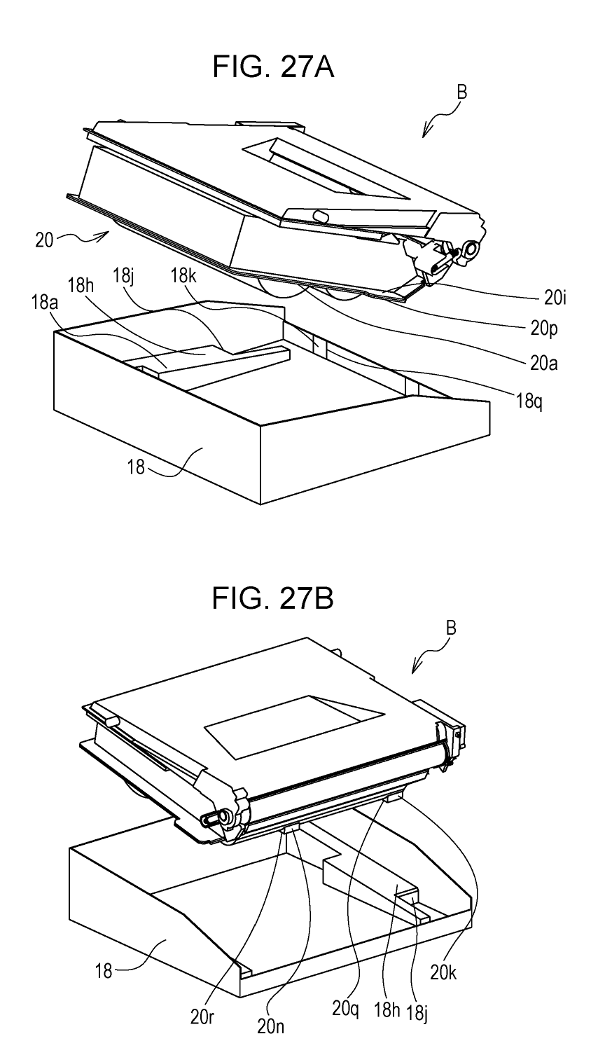

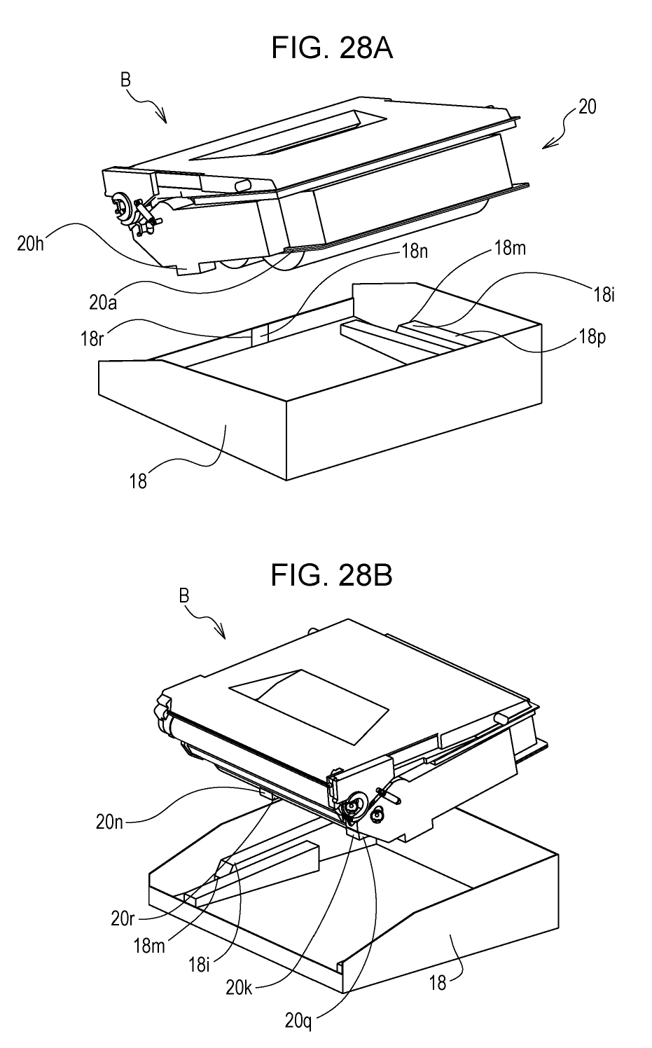

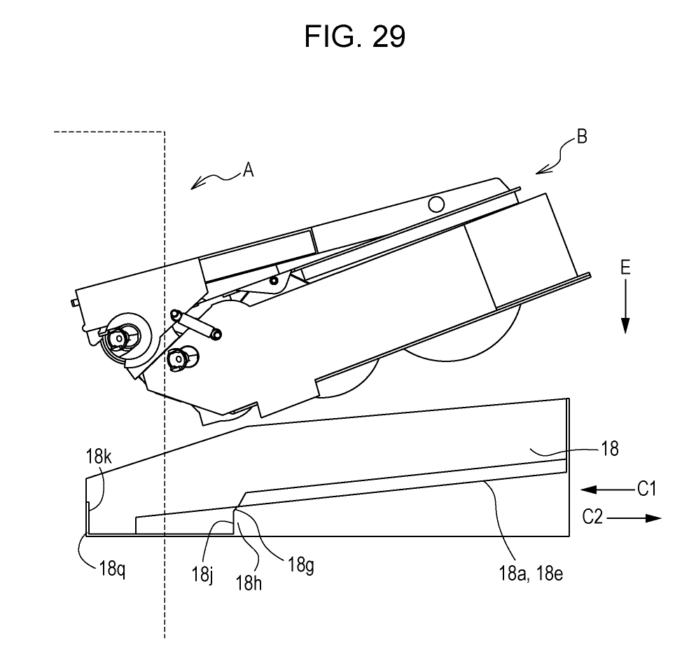

Mounting and demounting of the cartridge B with respect to the tray 18 will be described. FIG. 26 is a schematic drawing illustrating a state in which the cartridge B is mounted on the tray. FIGS. 27A and 27B, and FIGS. 28A and 28B are perspective views illustrating elements of the cartridge B and the tray 18. FIGS. 29, 30, and 31 are schematic illustration of a positional relationship between the cartridge B and the tray 18 at the time of mounting and demounting illustrated in chronological order.

As illustrated in FIGS. 27A and 27B and FIGS. 28A and 28B, the developing unit 20 of the cartridge B includes position-restricted portions 20h, 20i, 20q and 20r (which correspond respectively to first, second, third, and fourth position-restricted portions 20h, 20i, 20q, and 20r) disposed on a bottom surface thereof. The tray 18 also includes position restricting portions 18h, 18i, 18q, and 18r (which correspond respectively to first, second, third, and fourth position restricting portions 18h, 18i, 18q, and 18r) disposed thereon. As illustrated in FIG. 26, when the cartridge B is moved in a direction indicated by an arrow C1 by a certain extent in a state in which the cartridge B is mounted on the tray 18, the first position-restricted portion 20h and the first position restricting portion 18h provided on a drive-side come into contact with each other. In the same manner, when the cartridge B is moved in a direction indicated by an arrow C2 by a certain extent, the third position-restricted portion 20q and the third position restricting portion 18q come into contact with each other, so that the cartridge B is restricted from moving in the directions indicated by the arrow C1 and C2 with respect to the tray 18. In the same manner, on a non-drive-side as well, the second position-restricted portion 20i comes into contact with the second position restricting portion 18i and the fourth position-restricted portion 20r comes into contact with the fourth position restricting portion 18r, so that the cartridge B is restricted from moving in the directions indicated by the arrows C1 and C2 with respect to the tray 18 (not illustrated).

As illustrated in FIG. 26, on the drive-side, the first position restricting portion 18h includes a first contact surface 18j and the third position restricting portion 18q includes a third contact surface 18k. The first position-restricted portion 20h includes a first contacted surface 20j which comes into contact with the first contact surface 18j, and the third position-restricted portion 20q includes a third contacted surface 20k which comes into contact with the third contact surface 18k.

In the same manner, on the non-drive-side, the second position restricting portion 18i includes a second contact surface 18m and the fourth position restricting portion 18r includes a fourth contact surface 18n. The second position-restricted portion 20i includes a second contacted surface 20m which comes into contact with the second contact surface 18m, and the fourth position-restricted portion 20r includes a fourth contacted surface 20n which comes into contact with the fourth contact surface 18n (not illustrated).

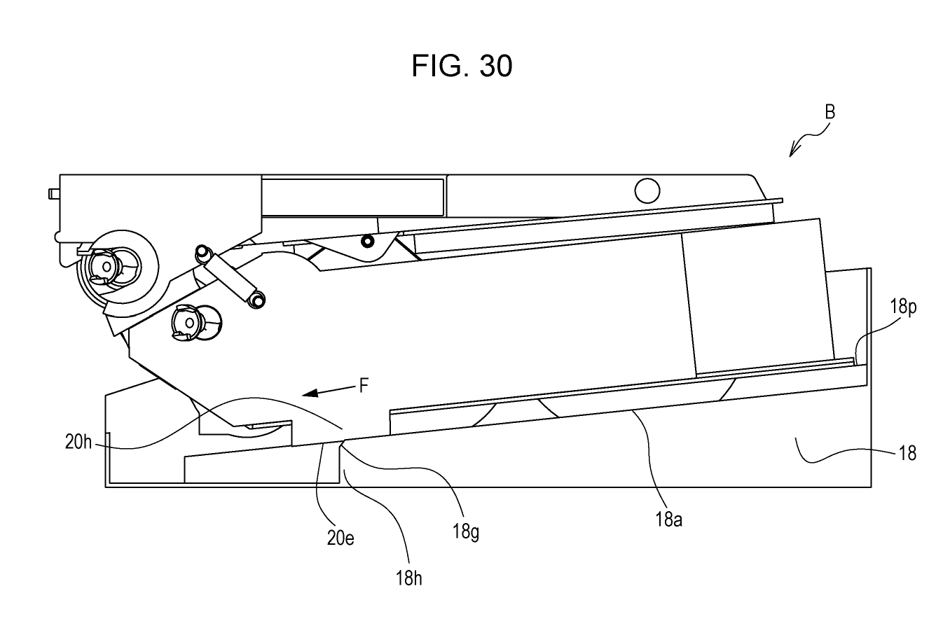

Next, mounting and demounting of the cartridge B with respect to the tray 18 will be described with reference to FIGS. 28A and 28B, FIG. 29, and FIG. 30. FIG. 29 illustrates a state in which the opening and closing door 13 (see FIG. 6) is opened, the tray 18 is drawn out from an image forming position and is at a mounting and demounting position at which the cartridge B can be mounted on and demounted from the tray 18. In FIG. 29, when a user grips a grip, which is not illustrated, the cartridge B is mounted on the tray 18 from a direction indicated by an arrow E in FIG. 29, and the bottom surface 20e of the first position-restricted portion 20h comes into contact with the supporting surface 18a as illustrated in FIG. 30. A bottom surface 20p of the second position-restricted portion 20i illustrated in FIG. 27A comes into contact with a supporting surface 18p illustrated in FIG. 28A. At this time, the supporting surfaces 18a and 18p are inclined, and the user is allowed to move the cartridge B in a direction indicated by an arrow F in FIG. 30 in a state in which the first position-restricted portion 20b is in contact with the supporting surface 18a and the second position-restricted portion 20i is in contact with the supporting surface 18p. In other words, the supporting surfaces 18a and 18p are guides (supporting-member-side guide portions) configured to come into contact with the first and second position-restricted portions 20h and 20i to guide the cartridge B to be mounted on the tray 18.

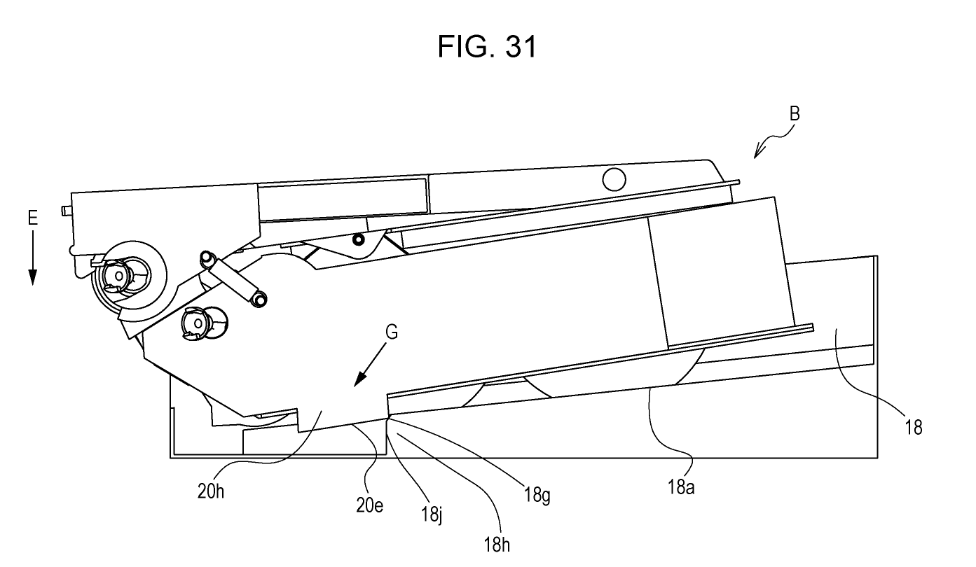

When the cartridge B is moved along the supporting surfaces 18a and 18p in the direction indicated by the arrow F by a certain extent or more, the bottom surface 20e of the first position-restricted portion 20h comes out of contact with the supporting surface 18a and comes into contact with an inclined surface 18g as illustrated in FIG. 31. The inclination of the inclined surface 18g is larger than the inclination of the supporting surface 18a, and is an inclination which allows the first position-restricted portion 20h to slide downward with respect to the inclined surface 18g under the weight of the cartridge B when the bottom surface 20e comes into contact therewith. Therefore, in the state illustrated in FIG. 31, the cartridge B moves in a direction indicated by an arrow G along the inclined surface 18g. After the cartridge B has slipped by a certain extent and thus the bottom surface 20e and the inclined surface 18g have come out of contact with each other, the cartridge B moves in a direction indicated by an arrow E under its own weight. Consequently, as illustrated in FIG. 26, the first position-restricted portion 20h and the third position-restricted portion 20q are arranged between the first position restricting portion 18h and the third position restricting portion 18q. At the same timing, the bottom surface 20p of the second position-restricted portion 20i is released from being supported by the supporting surface 18p, and the second position-restricted portion 20i and the fourth position-restricted portion 20r are arranged between the second position restricting portion 18i and the fourth position restricting portion 18r (not illustrated). A state in which the supported surface 20a is supported by the supporting surface 18a, and hence mounting on the tray 18 is completed.

Mounting and Demounting of Cartridge to main body of the apparatus

FIG. 26 is a drawing illustrating a state in which the cartridge B is mounted on the tray 18 from the drive-side. The first position-restricted portion 20h and the second position-restricted portion 20q are disposed on a bottom surface of the developing unit 20 as downward projecting portions. The first position-restricted portion 20h is provided with the first contacted surface 20j, and the third position-restricted portion 20q is provided with the third contacted surface 20k disposed thereon. When the cartridge B is mounted on the tray 18, a gap t3 exists between the first contact surface 18j and the first contacted surface 20j, and a gap t4 exists between the second contact surface 18k and the second contacted surface 20k. Therefore, the cartridge B is movable in the direction indicated by the arrow C1 by an amount corresponding to the gap t3, and is movable in the direction indicated by the arrow C2 by an amount corresponding to the gap t4 with respect to the tray 18. The first and third position restricting portions 18h and 18q come into contact with the first and third position-restricted portions 20h and 20q, so that a range in which the cartridge B is movable with respect to the tray 18 is restricted within a range of a gap (t3+t4).

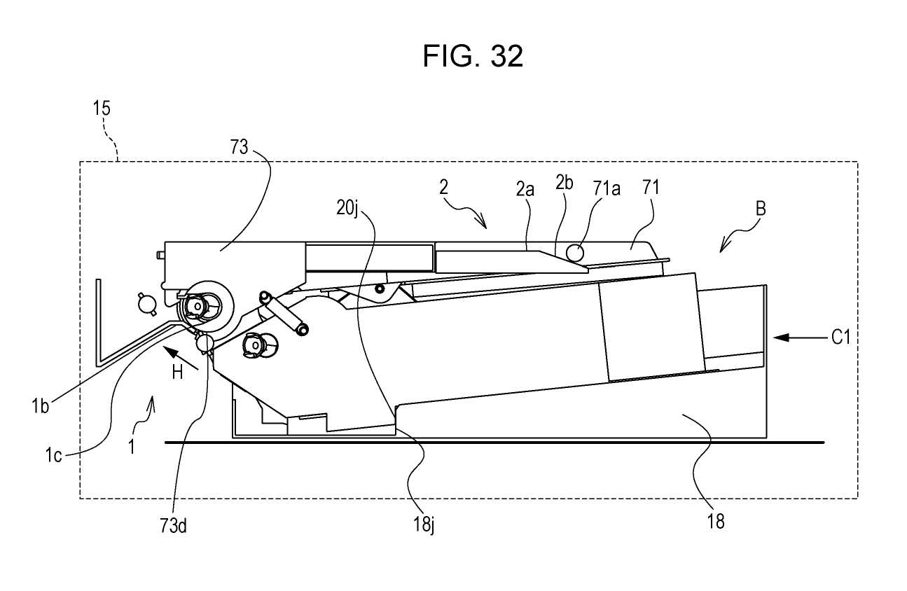

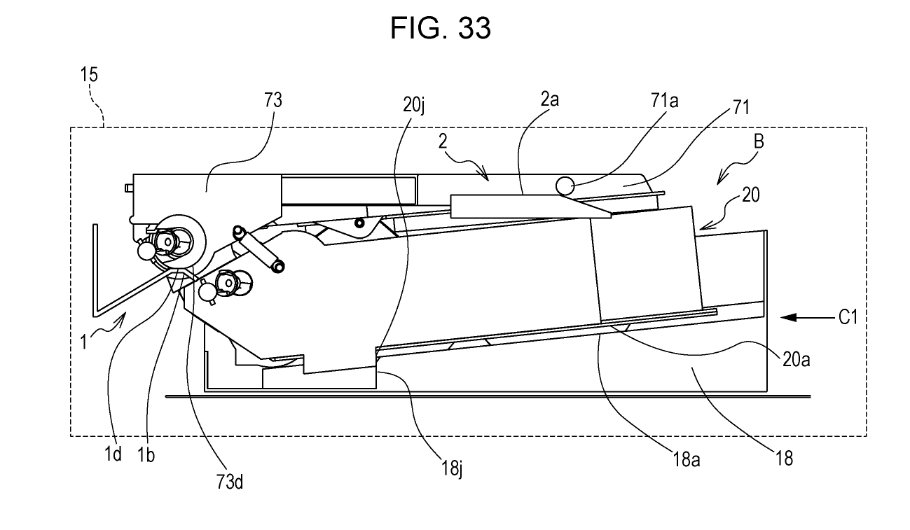

Mounting of the cartridge B on the main body A will be described first. When the tray 18 is pressed in the direction indicated by the arrow C1 in FIG. 26, the tray 18 moves in the direction indicated by the arrow C1, the first contact surface 18j provided on the tray 18 and the first contacted surface 20j come into contact, and the process cartridge B moves in the direction indicated by the arrow C1 in FIG. 26 by a force from the tray 18. Since the first contact surface 18j and the first contacted surface 20j are in contact with each other, if the tray 18 is moved in the direction indicated by the arrow C1 in FIG. 32, the tray 18 moves in the direction C1. A subsequent procedure until the cartridge B is moved in the direction indicated by the arrow C1 to complete mounting of the cartridge B on the main body A is the same as that in Example 1, and thus description is omitted.

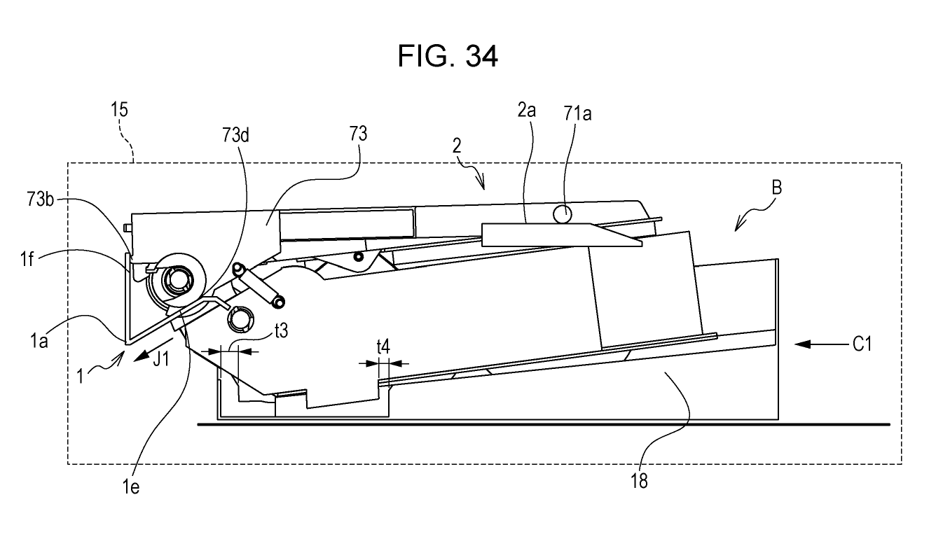

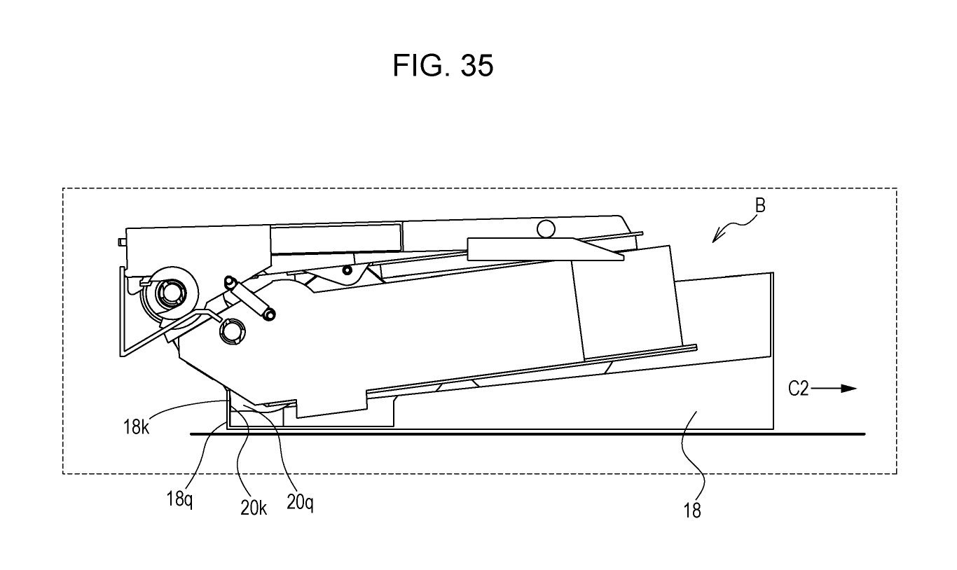

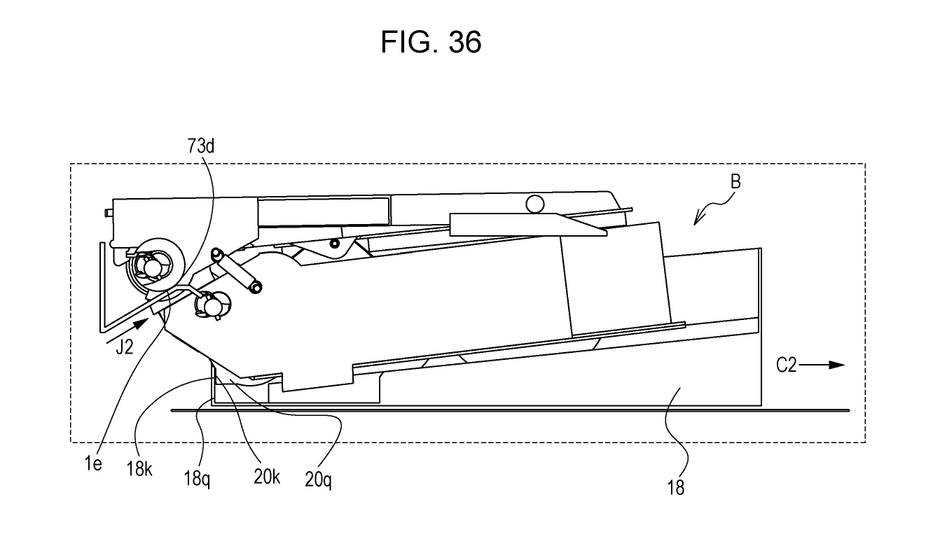

Next, demounting of the cartridge B from the main body A will now be described. In a state in which mounting of the process cartridge B on the main body A is completed as illustrated in FIG. 34, the gaps t3 and t4 are provided between the first contact surface 18j and the first contacted surface 20j and between the third contact surface 18k and the third contacted surface 20k. In this state, the cartridge B is in a state of being positioned by the supporting portion 1a and the rotation restricting surface 2a. Therefore, as illustrated in FIG. 35, when the tray 18 is moved in the direction indicated by an arrow C2 in FIG. 35, only the tray 18 is moved. In other words, the cartridge B is moved relatively in the opposite direction to the direction indicated by the arrow C2 with respect to the tray 18. Consequently, the gap t3 between the third position-restricted portion 20q and the third position restricting portion 18q (see FIG. 34) disappear and the third contact surface 18k comes into contact with the third contacted surface 20k. In addition, as illustrated in FIG. 36, the process cartridge B moves ongoingly in a direction indicated by an arrow J2 in FIG. 36 by the supporting portion 73d guided by the supporting surface 1e in association with the movement of the tray 18 in the direction C2. A contact relationship between the second and fourth position restricting portions 18i and 18r and the second and fourth position-restricted portions 20i and 20r on the non-drive-side is the same as the contact relationship between the first and third position restricting portions 18h and 18q and the first and third position-restricted portions 20h and 20q on the drive-side, and thus description will be omitted.

In conclusion, summary of the configuration of the example described thus far is as follows. The position-restricted portions 20h, 20i, 20q, and 20r are provided on the developing unit 20 of the cartridge B as a mechanism for limiting the movement of the cartridge B with respect to the tray 18 within a certain range. The tray 18 is provided with the position restricting portions 18h, 18i, 18q, and 18r configured to engage the position-restricted portions 20h, 20i, 20q, and 20r. In this example, a position on the cartridge B subjected to an impact when mounting the cartridge B on the main body A is different from that when demounting the cartridge B from the main body A. Therefore, the cartridge B having a higher durability than that in Example 1 is achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-242593 filed Nov. 28, 2014, which is hereby incorporated by reference herein in its entirety.

What is claimed is:

1. An image forming apparatus comprising:
a main body of the apparatus;
a cartridge having a first unit and a second unit pivotably coupled to the first unit; and
a cartridge supporting member configured to be movable with respect to the main body in a state in which the cartridge is mounted to take a mounting and demounting position where the cartridge supporting member is located at an exterior of the main body of the apparatus and allowing the cartridge to be mounted and demounted and an image forming position where the cartridge supporting member is located within an interior of the main body to locate the cartridge at a position which allows formation of an image,
wherein the first unit includes a position-restricted portion, and is located below the second unit in a state in which the cartridge is mounted on the cartridge supporting member, and
wherein the cartridge supporting member includes a position restricting portion configured to restrict movement of the cartridge with respect to the cartridge supporting member by coming into contact with the position-restricted portion.

2. The image forming apparatus according to claim 1, wherein the position-restricted portion is a projecting portion projecting downward from the first unit in a state in which the cartridge is mounted on the cartridge supporting member.

3. The image forming apparatus according to claim 2, wherein the position restricting portion includes a space for allowing the projecting portion to enter.

4. The image forming apparatus according to claim 1, wherein the position-restricted portion is provided on a bottom surface of the first unit in a state in which the cartridge is mounted on the cartridge supporting member.

5. The image forming apparatus according to claim 1, wherein the position-restricted portion and the position restricting portion engage each other via a gap which allows movement of the position-restricted portion, and
wherein the position-restricted portion moves with respect to the position restricting portion and the cartridge moves from a state of being supported by the cartridge supporting member to a state of being supported by the main body in association with the movement of the cartridge supporting member from the mounting and demounting position to the image forming position.

6. The image forming apparatus according to claim 1, wherein the second unit includes an image bearing member on which a latent image is formed, and wherein the first unit includes a developer bearing member configured to bear a developer to develop the latent image.

7. The image forming apparatus according to claim 6, wherein the second unit includes a supported portion,
the main body of the apparatus includes a supporting portion configured to support the supported portion and position the image bearing member provided on the second unit at a position which allows formation of an image, and
the supported portion is supported by the supporting portion in association with the movement of the cartridge supporting member from the mounting and demounting position to the image forming position.

8. The image forming apparatus according to claim 7, wherein the second unit includes a rotation-restricted portion,
the main body of the apparatus includes a rotation-restricting portion configured to come into contact with the rotation-restricted portion in a state in which the supported portion is supported by the supporting portion, and
the rotation-restricting portion comes into contact with the rotation-restricted portion to suppress the cartridge from rotating about the supporting portion.

9. The image forming apparatus according to claim 8, wherein a position of an upper end of the cartridge supporting member is lower than a contact position between the rotation-restricting portion and the rotation-restricted portion in a state in which the cartridge supporting member is located at the image forming position.

10. The image forming apparatus according to claim 8, wherein the rotation-restricting portion includes:
a main body side guide portion configured to guide the cartridge to be mounted on the main body of the apparatus by coming into contact with the rotation-restricted portion when the cartridge supporting member moves from the mounting and demounting position to the image forming position.

11. The image forming apparatus according to claim 1, wherein the cartridge mounted on the cartridge supporting member is partly located in the interior of the main body of the apparatus when the cartridge supporting member is at the mounting and demounting position.

12. The image forming apparatus according to claim 1, wherein the cartridge supporting member includes a supporting-member-side guide portion configured to come into contact with the cartridge to guide the cartridge to be mounted on the cartridge supporting member.

13. The image forming apparatus according to claim 12, wherein the supporting-member-side guide portion guides the cartridge to be mounted on the cartridge supporting member by coming into contact with the position-restricted portion, and guides the position-restricted portion to the position restricting portion.

14. The image forming apparatus according to claim 13, wherein a step is formed between the supporting-member-side guide portion and the position restricting portion.

15. The image forming apparatus according to claim 12, wherein the supporting-member-side guide portion includes an inclined portion inclining downward in a direction of guiding the cartridge to be mounted.

16. The image forming apparatus according to claim 1, wherein the position restricting portion comes into contact with the position-restricted portion when the cartridge supporting member is moved from the mounting and demounting position toward the image forming position, and hence the cartridge is moved at least in a first direction, which is a direction in which the cartridge supporting member moves from the mounting and demounting position toward the image forming position.

17. The image forming apparatus according to claim 1, wherein the position restricting portion comes into contact with the position-restricted portion when the cartridge supporting member is moved from the image forming position toward the mounting and demounting position, and hence the cartridge is moved at least in a second direction, which is a direction in which the cartridge supporting member moves from the image forming position toward the mounting and demounting position.

18. The image forming apparatus according to claim 2, wherein the first unit includes at least two of the projecting portions.

19. The image forming apparatus according to claim 18, wherein the cartridge supporting member includes at least two of the position restricting portions.
